(19) United States
(12) Patent Application Publication
(10) Pub. No.: US 2025/0301107 A1
(43) Pub. Date: Sep. 25, 2025

(54) PROJECTION DEVICE AND METHOD FOR DRIVING LIGHT SOURCE OF PROJECTION DEVICE

(71) Applicant: HISENSE LASER DISPLAY CO., LTD., Shandong (CN)

(72) Inventors: Libo GAO, Shandong (CN); Xigang ZHANG, Shandong (CN); Pengpeng LIU, Shandong (CN)

(21) Appl. No.: 19/227,284

(22) Filed: Jun. 3, 2025

Related U.S. Application Data
(63) Continuation of application No. PCT/CN2024/075097, filed on Jan. 31, 2024.

(30) Foreign Application Priority Data
Feb. 16, 2023 (CN) 202310127193.6
Feb. 16, 2023 (CN) 202310127204.0
Feb. 16, 2023 (CN) 202310127228.6
Feb. 16, 2023 (CN) 202310127831.4

(51) Int. Cl. H04N 9/31; G09G 3/00

(52) U.S. Cl. CPC H04N 9/3155; G09G 3/001; H04N 9/3123; H04N 9/3164; H04N 9/3161

(57) ABSTRACT

A projection device, including: a plurality of light sources having different colors; a first driving circuit configured to supply a first current to the light sources based on a first enable signal and at least one first driving signal; at least one switching circuit configured to turn on or turn off the first current supplied to the light sources based on at least one first switching signal; and a control circuit configured to supply the first enable signal and the at least one first driving signal and supply the at least one first switching signal based on light emission information of the light sources, to enable the light sources to emit light in different light-emitting periods respectively according to the light emission information, wherein the light emission information comprises a light-emitting timing sequence, a light-emitting duration and a rated current.

This application is a continuation of PCT international application No. PCT/CN2024/075097 filed Jan. 31, 2024, which claims priority to Chinese Patent Application No. 202310127204.0 filed Feb. 16, 2023, Chinese Patent Application No. 202310127228.6 filed Feb. 16, 2023, Chinese Patent Application No. 202310127831.4 filed Feb. 16, 2023, and Chinese Patent Application No. 202310127193.6 filed Feb. 16, 2023, the disclosures of which are herein incorporated by reference in their entireties.

### TECHNICAL FIELD

The present disclosure relates to the field of projection device technology and more particularly to a projection device and a method for driving a light source of a projection device.

### BACKGROUND

With the development of the projection device technology, users have an increasingly higher requirement on the projection effect of a projection device. A laser light source is more and more applied to the projection device because the laser light source has characteristics of high luminance, long lifespan, small volume, low power consumption and the like.

### SUMMARY

In one aspect, a projection device is provided. The projection device includes: a plurality of light sources, wherein different light sources emit different colors of light; a first driving circuit connected to the plurality of light sources, wherein the first driving circuit is configured to supply a first current to the plurality of light sources based on a first enable signal and at least one first driving signal; at least one switching circuit connected to the plurality of light sources, wherein the at least one switching circuit is configured to turn on or turn off the first current supplied to the plurality of light sources based on at least one first switching signal; and a control circuit respectively connected to the first driving circuit and the at least one switching circuit, wherein the control circuit is configured to supply the first enable signal and the at least one first driving signal to the first driving circuit and supply the at least one first switching signal to the at least one switching circuit based on light emission information of the plurality of light sources, to enable the plurality of light sources to emit light in different light-emitting periods respectively based on the light emission information, wherein the light emission information includes a light-emitting timing sequence, a light-emitting duration and a rated current.

In another aspect, a projection device is provided. The projection device includes: a plurality of light sources including a first light source and a plurality of fourth light sources, wherein different light sources emit different colors of light; a second driving circuit connected to the first light source, wherein the second driving circuit is configured to supply a second current to the first light source based on a second enable signal and a second driving signal; a third driving circuit connected to the plurality of fourth light sources, wherein the third driving circuit is configured to supply a third current to the plurality of fourth light sources based on a third enable signal and at least one third driving signal; at least one switching circuit connected to the plurality of fourth light sources, wherein the at least one switching circuit is configured to turn on or turn off the first current supplied to the plurality of fourth light sources based on at least one first switching signal; and a control circuit connected to the second driving circuit, the third driving circuit and the at least one switching circuit, wherein the control circuit is configured to supply the second enable signal and the second driving signal to the second driving circuit, supply the third enable signal and the at least one third driving signal to the third driving circuit, and supply the at least one first switching signal to the at least one switching circuit based on light emission information of the plurality of light sources, to enable the plurality of light sources to emit light in different light-emitting periods respectively based on the light emission information, wherein the light emission information includes a light-emitting timing sequence, a light-emitting duration and a rated current.

### BRIEF DESCRIPTION OF DRAWINGS

FIG. 1 is a circuit diagram of a projection device in the related art;

FIG. 2 is a circuit diagram of a projection device according to some embodiments of the present disclosure;

FIG. 3 is a circuit diagram of another projection device according to some embodiments of the present disclosure;

FIG. 4 is a waveform diagram of a plurality of signals according to some embodiments of the present disclosure;

FIG. 5 is a circuit diagram of another projection device according to some embodiments of the present disclosure;

FIG. 6 is a circuit diagram of another projection device according to some embodiments of the present disclosure;

FIG. 7 is a circuit diagram of another projection device according to some embodiments of the present disclosure;

FIG. 8 is a circuit diagram of another projection device according to some embodiments of the present disclosure;

FIG. 9 is a circuit diagram of another projection device according to some embodiments of the present disclosure;

FIG. 10 is a circuit diagram of another projection device according to some embodiments of the present disclosure;

FIG. 11 is another waveform diagram of a plurality of signals according to some embodiments of the present disclosure;

FIG. 12 is a circuit diagram of another projection device according to some embodiments of the present disclosure;

FIG. 13 is a circuit diagram of another projection device according to some embodiments of the present disclosure;

FIG. 14 is a circuit diagram of another projection device according to some embodiments of the present disclosure;

FIG. 15 is a circuit diagram of another projection device according to some embodiments of the present disclosure;

FIG. 16 is a circuit diagram of another projection device according to some embodiments of the present disclosure;

FIG. 17 is another waveform diagram of a plurality of signals according to some embodiments of the present disclosure;

FIG. 18 is a circuit diagram of another projection device according to some embodiments of the present disclosure;

FIG. 19 is a circuit diagram of another projection device according to some embodiments of the present disclosure;

FIG. 20 is a circuit diagram of another projection device according to some embodiments of the present disclosure;

FIG. 21 is a circuit diagram of another projection device according to some embodiments of the present disclosure;

FIG. 22 is a circuit diagram of another projection device according to some embodiments of the present disclosure;

FIG. 23 is a circuit diagram of another projection device according to some embodiments of the present disclosure;

FIG. 24 is another waveform diagram of a plurality of signals according to some embodiments of the present disclosure;

FIG. 25 is a circuit diagram of another projection device according to some embodiments of the present disclosure;

FIG. 26 is a flowchart of a method for driving a light source of a projection device according to some embodiments of the present disclosure;

FIG. 27 is another flowchart of a method for driving a light source of a projection device according to some embodiments of the present disclosure;

FIG. 28 is another flowchart of a method for driving a light source of a projection device according to some embodiments of the present disclosure;

FIG. 29 is another flowchart of a method for driving a light source of a projection device according to some embodiments of the present disclosure;

FIG. 30 is another flowchart of a method for driving a light source of a projection device according to some embodiments of the present disclosure;

FIG. 31 is another flowchart of a method for driving a light source of a projection device according to some embodiments of the present disclosure;

FIG. 32 is another flowchart of a method for driving a light source of a projection device according to some embodiments of the present disclosure;

FIG. 33 is another flowchart of a method for driving a light source of a projection device according to some embodiments of the present disclosure; and

FIG. 34 is a circuit diagram of a laser projection device according to some embodiments of the present disclosure.

### DETAILED DESCRIPTION

Hereinafter, some embodiments of the present disclosure will be described clearly and completely in conjunction with the accompanying drawings. The described embodiments are merely some embodiments of the present disclosure, rather than all embodiments of the present disclosure. Based on the embodiments provided in the present disclosure, all other embodiments derived by those of ordinary skill in the art shall fall within the protection scope of the present disclosure.

Unless specified otherwise in the context, in the entire specification and claims, the term “comprise” and other forms thereof such as “comprises” of the singular form in third personal and “comprising” of the present participle form are construed as being open and inclusive, i.e., “comprises but is not limited to”. In the description of the specification, the terms “one embodiment”, “some embodiments”, “exemplary embodiments”, “example”, “specific example”, “some examples” and the like are intended to express that a specific feature, structure, material or characteristic related to the embodiment or example is included in at least one embodiment or example of the present disclosure. The illustrative expressions of the above terms do not necessarily refer to the same embodiment or example. Additionally, the specific feature, structure, material or characteristic may be included in any one or more embodiments or example in any suitable manner.

The terms “first” and “second” are used for descriptive purpose only and cannot be construed as indicating or implying any relative importance or implicitly indicating the quantity of indicated technical features. Thus, the feature defined by “first” or “second” may explicitly or implicitly includes one or more of such features. In the descriptions of the embodiments of the present disclosure, “a plurality of” refers to two or more unless specified otherwise.

In the descriptions of some embodiments, “connection” and derivative expressions thereof may be used. The term “connection” should be understood in a broad sense, for example, a “connection” may be a fixed connection, detachable connection, or an integrity, and the “connection” may be a direction connection or an indirect connection through intermediate medium. The embodiments disclosed herein are not limited the contents in the present disclosure.

“At least one of A, B and C (at least one element in a set of {A, B, C})” has the same meaning as “At least one of A, B or C”, both of which may only A, only B, only C, a combination of A and B, a combination of A and C, a combination of B and C, and a combination of A, B and C.

“Being applicable to” or “being configured to” in the present disclosure has an open and inclusive meaning, without excluding that a device is appliable to or configured to perform additional tasks or steps.

As used in the present disclosure, a value defined by “about”, “roughly” or “approximately” includes the described value and an average within an acceptable deviation range of a specific value. The acceptable deviation range is determined by a person of ordinary skill in the art in consideration of measurements being discussed and errors related to a specific measurement (i.e., limitation of a measuring system).

Generally, a projection device needs at least three driving circuits to drive a laser emitting red laser light, a laser emitting green laser light and a laser emitting blue laser light respectively to emit light, and the driving circuit usually adopts a boost circuit, a buck circuit or a buck-boost circuit. However, each of the three driving circuits needs a large number of inductors, driving chips, metal-oxide semiconductor field-effect transistors (MOSFETs), resistors and diodes. Thus, the three driving circuits occupy a larger area, and the cost is higher. In addition, when a plurality of MOSFETs adjust a plurality of lasers respectively to emit light or stop emitting light, the plurality of MOSFETs need to be turned on or turned off frequently, which generates a large amount of electromagnetic radiation, resulting in an electromagnetic compatibility (EMC) problem. As a result, the reliability of the projection device in the usage environment is reduced.

FIG. 1 is a circuit diagram of a projection device in the related art. As shown in FIG. 1, the projection device 1000 includes a control circuit 1001, a plurality of driving circuits 1002, a plurality of light sources 1003 and a plurality of first circuits 1004. The plurality of light sources 1003 emit different colors of laser light from each other, and the plurality of driving circuits 1002 and the plurality of first circuits 1004 are arranged in correspondence to the plurality of light sources 1003, respectively. The plurality of light sources 1003 include a first light source 10031, a second light source 10032 and a third light source 10033. The first light source 10031 emits red laser light, the second light source 10032 emits blue laser light, and the third light source 10033 emits green laser light. The first circuit 1004 includes a first inductor L11, a first diode D11 and a first transistor M11. The first circuits 1004 regulate the currents flowing through the plurality of light sources 1003.

A circuit consisting of one light source 1003, and the driving circuit 1002 and the first circuit 1004 that correspond to the light source 1003 is referred to as a buck circuit, and the buck circuit is integrated on a circuit board controlling the light source 1003 in the projection device 1000.

When the control circuit 1001 outputs a first enable signal 110 of a third level and a first driving signal 120 to the driving circuit 1002 corresponding to the first light source 10031, the driving circuit 1002 outputs a current to the first light source 10031 through the inductor L2 and outputs a first switching signal 130 to the gate G of the first transistor M31. The first transistor M31 switches from off to on based on the first switching signal 130 of the first level, to enable the first light source 10031 to emit light. When the control circuit 1001 outputs a first enable signal 110 of a second level to the driving circuit 1002 corresponding to the first light source 10031 and stops outputting the first driving signal 120 to the driving circuit 1002 corresponding to the first light source 10031, the driving circuit 1002 stops outputting the current to the first light source 10031 and outputs the first switching signal 130 of the second level to the gate G of the first transistor M31. The first transistor M31 switches from on to off based on the first switching signal 130 of the second level, to enable the first light source 10031 to stop emitting light. The principles of emitting light and stopping emitting light of the second light source 10032 and the third light source 10033 are similar to those of the first light source 10031, respectively, which are not repeated any further.

As shown in FIG. 1, the projection device 1000 further includes a plurality of first sampling resistors R11. The plurality of first sampling resistors R11 are respectively connected to the plurality of first circuits 1004 and the plurality of driving circuits 1002, and the plurality of first sampling resistors R11 sample the currents flowing through the respectively light sources 1003, respectively. The plurality of first circuits 1004 regulate the currents flowing through the plurality of light sources 1003 respectively based on the currents sampled by the plurality of first sampling resistors R11.

It is to be understood that when the plurality of light sources 1003 emit light in sequence, the plurality of first transistors M31 in the plurality of first circuits 1004 corresponding to plurality of light sources 1003 switch between on and off at high speed respectively, which generates a large amount of electromagnetic radiation, resulting in the electromagnetic compatibility problem. Therefore, the projection device 1000 needs to be provided with a magnetic ring or other devices that can shield electromagnetic radiation to reduce the electromagnetic radiation. Furthermore, the plurality of first transistors M31 generate a large amount of heat during the switching process between one and off. Therefore, the projection device 1000 also needs to be provided with a heat dissipation device (such as a heat sink) for cooling. Therefore, the structure of the projection device 1000 is relatively complex and the cost is relatively high.

To solve the above problems, some embodiments of the present disclosure provide a projection device 100. In the case where a plurality of light sources emitting different colors of light beams emit light in sequence, by reducing the number of the driving circuits and switching circuits, the structure of the projection device 100 can be simplified and the cost of the projection device 100 is reduced.

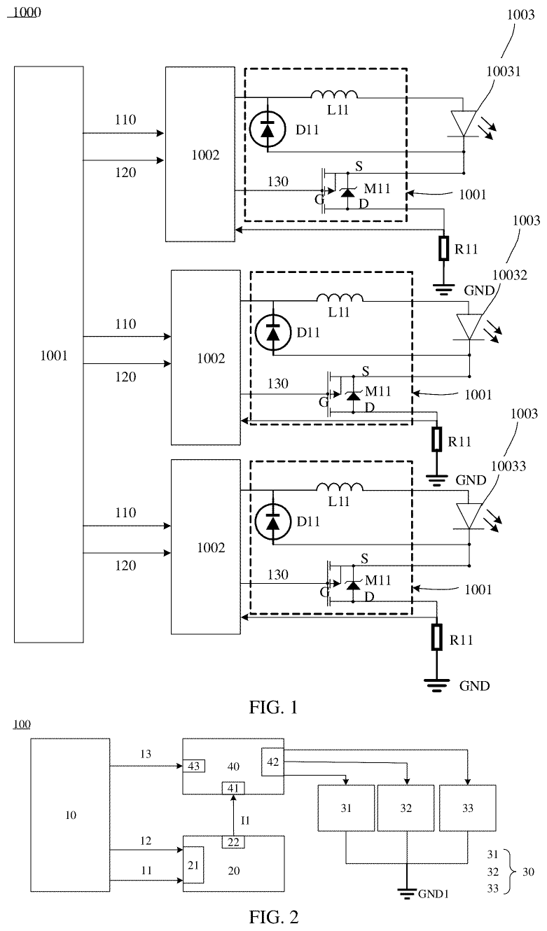

FIG. 2 is a circuit diagram of a projection device according to some embodiments of the present disclosure. As shown in FIG. 2, the projection device 100 includes a control circuit 10, a first driving circuit 20, a first switching circuit 40, and a plurality of light sources 30. The plurality of light sources 30 are configured to emit a plurality of light beams of different colors, and each of the plurality of light sources 30 may be a laser. For example, the plurality of light sources 30 include a first light source 31, a second light source 32 and a third light source 33. The first light source 31, the second light source 32 and the third light source 33 are all lasers, and the first light source 31 emits red laser light, the second light source 32 emits green laser light, and the third light source 33 emits blue laser light.

The above description takes an example where the plurality of light sources 30 include three light sources 30 and the colors of these three light sources 30 are different from each other. The plurality of light sources 30 may also include two or other numbers of light sources 30, each light source 30 may also emit light beams of other colors, and at least two of the plurality of light sources 30 emit light beams of the same color, such that at least one of the at least two light sources 30 that emit light beams of the same color serves as a spare light source, which is not limited in the present disclosure. The following description takes an example where the plurality of light sources 30 emit different colors of light beams from each other.

The control circuit 10 is configured to output a first enable signal 11 and at least one first driving signal 12 to the first driving circuit 20 and output at least one first switching signal 13 to the first switching circuit 40 based on the light emission information of the plurality of light sources 30. Here, the light emission information of the plurality of light sources 30 includes a light-emitting timing sequence, a light-emitting duration and a rated current of each of the plurality of light sources 30 within a unit duration (for example, 1 second). Moreover, the light-emitting timing sequences and durations of the plurality of light sources 30 within a unit duration are set respectively based on needs, which are not limited in the present disclosure. The light-emitting timing sequences of the plurality of light sources 30 within a unit duration are also referred to as set light-emitting timing sequences, and the light-emitting durations of the plurality of light sources 30 within a unit duration (for example, 1 second) are also referred to as set light-emitting durations.

In some embodiments, the control circuit 10 includes a digital light processing (DLP) chip. Alternatively, the control circuit 10 includes a microcontroller unit (MCU), which is also referred to as a single-chip microcomputer. Alternatively, the control circuit 10 includes a system on chip (SoC).

In some embodiments, the light emission information of the plurality of light sources 30 is pre-stored in the control circuit 10. Alternatively, the projection device 100 further includes a memory, and the light emission information of the plurality of light sources 30 is stored in the memory. When the control circuit 10 is powered on and started, the control circuit 10 obtains the light emission information of the plurality of light sources 30 from the memory.

A first input terminal 21 of the first driving circuit 20 is connected to the control circuit 10, and the first driving circuit 20 is configured to output the first current I1 based on the first enable signal 11 and the first driving signal 12 to drive the corresponding light source 30 to emit light. Here, the first driving circuit 20 includes a constant current driving integrated circuit (IC), which may also be referred to as a constant current driving chip.

The first enable signal 11 is configured to control the first driving circuit 20 to output or not to output the first current I1. The first driving signal 12 is configured to control a current value of the first current I1 output by the first driving circuit 20. The first driving signal 12 is a pulse width modulation (PWM) signal. For example, the first current I1 is positively correlated with the duty ratio of the first driving signal 12. The larger the duty ratio of the first driving signal 12, the larger the current value of the first current I1, and accordingly, the higher the luminance of the light source 30 driven by the first current I1.

It should be noted that the first driving circuit 20 drives only one light source 30 to emit light in one period, which can prevent two or more light sources 30 of different colors from emitting light at the same time, thereby avoiding the color mixing problem of the plurality of light sources 30 during the light-emitting process and improving the display effect of the projected image.

The control terminal 43 of the first switching circuit 40 is connected to the control circuit 10, the first terminal 41 of the first switching circuit 40 is connected to the first output terminal 22 of the first driving circuit 20, the second terminal 42 of the first switching circuit 40 is connected to the first terminals of the plurality of light sources 30, and the second terminals of the plurality of light sources 30 are connected to a first grounding terminal GND1. The first switching circuit 40 is configured to turn on the connection between the first driving circuit 20 and the plurality of light sources 30 in sequence based on at least one first switching signal 13, to drive the plurality of light sources 30 to emit light in sequence, such that the projection device 100 displays a projected image. Here, the sequential light emission of the plurality of light sources 30 refers to that the light-emitting periods of the plurality of light sources 30 are staggered from each other.

When the projection device 100 is powered on and started, the control circuit 10 outputs the first switching signal 13 to the first switching circuit 40 based on the light emission information of the plurality of light sources 30, to control the turn-on and turn-off of the first switching circuit 40. Here, the turn-on and turn-off of the first switching circuit 40 refer to the connection and disconnection between the first terminal 41 of the first switching circuit 40 and the second terminal 42 of the first switching circuit 40, respectively.

In some embodiments of the present disclosure, the control circuit 10 outputs the first switching signal 13 to the first switching circuit 40 and outputs the first enable signal 11 and the first driving signal 12 to the first driving circuit 20 based on the light emission information of the plurality of light sources 30. The first switching circuit 40 controls, based on the first switching signal 13, the connection and disconnection between the first driving circuit 20 and any one of the plurality of light sources 30. In this way, with only one first driving circuit 20, the plurality of light sources 30 of different colors from each other can emit light in sequence, thereby effectively simplifying the structure of the projection device 100 and reducing the manufacturing cost.

FIG. 3 is another circuit diagram of a projection device according to some embodiments. In some embodiments, as shown in FIG. 3, the first switching circuit 40 includes a plurality of first transistors M1, and the plurality of first transistors M1 correspond to the plurality of light sources 30, respectively. The gates (G) of the plurality of first transistors M1 are the control terminals 43 of the first switching circuit 40, the first terminals of the plurality of first transistors M1 are the first terminals 41 of the first switching circuit 40, and the second terminals of the plurality of first transistors M1 are the second terminals 42 of the first switching circuit 40.

The plurality of first transistors M1 may be P-type metal oxide semiconductor (MOS) transistors respectively. Furthermore, the first terminals of the plurality of first transistors M1 are sources(S) respectively, and the second terminals of the plurality of first transistors M1 are drains (D) respectively.

In some embodiments, the at least one first switching signal 13 includes a plurality of first switching signals 13, and the plurality of light sources 30 correspond to the plurality of first switching signals 13, respectively. In the case where one switching circuit 40 includes a plurality of first transistors M1 and the plurality of first transistors M1 correspond to the plurality of light sources 30 respectively, the control circuit 10 is further configured to output a plurality of first switching signals 13 to the gates of the plurality of first transistors M1 to control the connection between the first driving circuit 20 the plurality of light sources 30 to be turned on or turned off.

The first switching signal 13 may be a level signal, and the first switching signal 13 includes a first sub-switching signal of a first level and a second sub-switching signal of a second level. For example, when the first transistor M1 receives the first sub-switching signal of the first level, the first transistor M1 turns on the connection between the first driving circuit 20 and the light source 30 corresponding to the first transistor M1. When the first transistor M1 receives the second sub-switching signal of the second level, the first transistor M1 turns off the connection between the first driving circuit 20 and the light source 30 corresponding to the first transistor M1. Here, the first level is a low level relative to the second level.

It should be noted that when the control circuit 10 outputs the corresponding first switching signals 13 to the gates G of the plurality of first transistors M1 respectively, the control circuit 10 in sequence outputs a plurality of first driving signals 12 corresponding to the plurality of light sources 30 to the first driving circuit 20. During the period of outputting the first driving signal 12 corresponding to one light source 30, the first transistor M1 corresponding to the light source 30 receives the first sub-switching signal of the first level.

In some embodiments, in the case where the first switching circuit 40 includes a plurality of first transistors M1 to control the light sources 30 to emit light through the plurality of first transistors M1, the control circuit 10 is further configured to: based on the light emission information of the plurality of light sources 30, output the first sub-switching signal of the first level to the gate G of the first transistor M1 corresponding to a target light source, output the second sub-switching signal of the second level to the gates G of the first transistors M1 corresponding to other light sources 30 in the plurality of light sources 30 except for the target light source, and output the first driving signal 12 corresponding to the target light source to the first driving circuit 20. The target light source is a light source 30 that needs to be illuminated currently as determined by the control circuit 10 based on the light-emitting timing sequences of the plurality of light sources 30.

In this case, the first driving circuit 20 is further configured to transmit, based on the first driving signal 12 corresponding to the target light source, the first current I1 to the source S of the first transistor M1 corresponding to the target light source. In this way, the source S and the drain D of the first transistor M1 are turned on, and the first current I1 output by the first driving circuit 20 drives the target light source to emit light.

It should be noted that during the period when the control circuit 10 outputs the first driving signal 12 corresponding to the target light source to the first driving circuit 20, the first transistor M1 is in an on state, and during the period when the control circuit 10 stops outputting the first driving signal 12 corresponding to the target light source to the first driving circuit 20, the first transistor M1 is in an off state.

In some embodiments, in the case where the first switching circuit 40 includes a plurality of first transistors M1 to control the light sources 30 to emit light through the plurality of first transistors M1, the control circuit 10 is further configured to: when outputting the first sub-switching signal of the first level to the gate of the first transistor M1 corresponding to the target light source for a set light-emitting duration, output the second sub-switching signal of the second level to the gate of the first transistor M1 corresponding to the target light source, output the first sub-switching signal to the gate of the first transistor M1 corresponding to another light source 30, and output a first driving signal 12 corresponding to the another light source 30 to the first driving circuit 20. The another light source 30 is a next light source that needs to emit light after the target light source emit lights for the set light-emitting duration.

It should be noted that the turn-on duration of the first transistor M1 corresponding to the target light source is the set light-emitting duration of the target light source. In the case where the control circuit 10 determines that the turn-on duration of the first transistor M1 corresponding to the target light source reaches the set light-emitting duration of the target light source, the control circuit 10 outputs the second sub-switching signal of the second level to the gate G of the first transistor M1, and outputs the first sub-switching signal of the first level to the gate G of the first transistor M1 corresponding to the another light source 30.

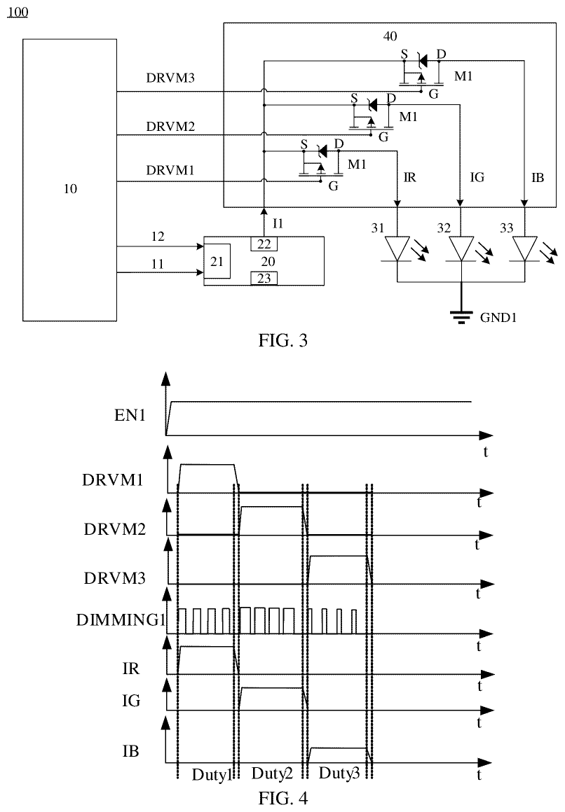

FIG. 4 is a waveform diagram of a plurality of signals according to some embodiments. In FIG. 4, EN1 represents the first enable signal 11, DIMMING1 represents the first driving signal 12, the first light-emitting duration Duty1 represents a set light-emitting duration of the first light source 31, the second light-emitting duration Duty2 represents a set light-emitting duration of the second light source 32, and the third light-emitting duration Duty3 represents a set light-emitting duration of the third light source 33. The first type of first switching signal DRVM1 represents a first switching signal 13 output by the control circuit 10 to the gate G of the first transistor M1 corresponding to the first light source 31. The second type of first switching signal DRVM2 represents a first switching signal 13 output by the control circuit 10 to the gate G of the first transistor M1 corresponding to the second light source 32. The third type of first switching signal DRVM3 represents a first switching signal 13 output by the control circuit 10 to the gate G of the first transistor M1 corresponding to the third light source 33. The first driving current IR represents a first current I1 output by the first driving circuit 20 to the first light source 31. The second driving current IG represents a first current I1 output by the first driving circuit 20 to the second light source 32. The third driving current IB represents a first current I1 output by the first driving circuit 20 to the third light source 33.

For example, as shown in FIG. 3 and FIG. 4, when the control circuit 10 is powered on and started, the control circuit 10 outputs the first type of first switching signal DRVM1 of the first level to the gate G of the first transistor M1 corresponding to the first light source 31, outputs the first driving signal 12 corresponding to the first light source 31 to the first driving circuit 20, outputs the second type of first switching signal DRVM2 of the second level to the gate G of the first transistor M1 corresponding to the second light source 32, and outputs the third type of first switching signal DRVM3 of the second level to the gate G of the first transistor M1 corresponding to the third light source 33.

At this time, the first driving current IR output by the first driving circuit 20 to the first light source 31 flows through the light source 31 to drive the first light source 31 to emit light. Furthermore, there is no current flowing through the second light source 32 and the third light source 33, and the second light source 32 and the third light source 33 stop emitting light.

When the light-emitting duration of the first light source 31 reaches the first light-emitting duration Duty1, the control circuit 10 outputs the first type of first switching signal DRVM1 of the second level to the first transistor M1 corresponding to the first light source 31, such that the first transistor M1 corresponding to the first light source 31 is turned off, and the control circuit 10 outputs the second type of first switching signal DRVM2 of the first level to the gate G of the first transistor M1 corresponding to the second light source 32, outputs the first driving signal 12 corresponding to the second light source 32 to the first driving circuit 20, and outputs the third type of first switching signal DRVM3 of the second level to the gate G of the first transistor M1 corresponding to the third light source 33.

At this time, the second driving current IG output by the first driving circuit 20 to the second light source 32 flows through the second light source 32 to drive the second light source 32 to emit light. Furthermore, there is no current flowing through the first light source 31 and the third light source 33, and the first light source 31 and the third light source 33 stop emitting light.

When the light-emitting duration of the second light source 32 reaches the second light-emitting duration Duty2, the control circuit 10 outputs the second type of first switching signal DRVM2 of the second level to the first transistor M1 corresponding to the second light source 32, such that the first transistor M1 corresponding to the second light source 32 is turned off, and the control circuit 10 outputs the third type of first switching signal DRVM3 of the first level to the gate G of the first transistor M1 corresponding to the third light source 33, and outputs the first driving signal 12 corresponding to the third light source 33 to the first driving circuit 20.

At this time, the third driving current IB output by the first driving circuit 20 to the third light source 33 flows through the third light source 33 to drive the third light source 33 to emit light. Furthermore, there is no current flowing through the first light source 31 and the second light source 32, and the first light source 31 and the second light source 32 stop emitting light.

The above descriptions are provided by taking an example where when the light-emitting duration of one light source 30 reaches the set light-emitting duration corresponding to the light source 30, the control circuit 10 outputs the second sub-switching signal of the second level to the gate G of the first transistor M1 corresponding to the light source 30 and outputs the first sub-switching signal to the gate G of the first transistor M1 corresponding to another light source 30 in the plurality of light sources 30.

In some embodiments, when the duration of outputting, by the control circuit 10, the second sub-switching signal of the second level to the gate G of the first transistor M1 corresponding to one light source 30 reaches a first target duration, the control circuit 10 outputs the first sub-switching signal of the first level to the gate G of the first transistor M1 corresponding to another light source 30 in the plurality of light sources 30. In this way, two light sources of different colors 30 can be prevented from emitting light simultaneously, thereby avoiding the color mixing problem during the light-emitting process of the plurality of light sources 30.

The first target duration is determined based on needs. Furthermore, the time interval (e.g., time delay) between the light-emitting periods of two adjacent light sources 30 in the plurality of light sources 30 is equal, which is not limited in the present disclosure.

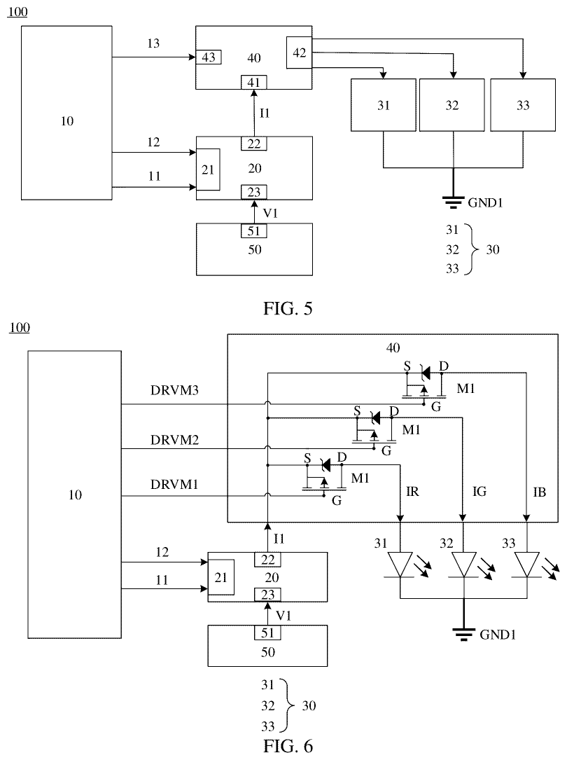

FIG. 5 is another circuit diagram of a projection device according to some embodiments. FIG. 6 is another circuit diagram of a projection device according to some embodiments. In some embodiments, as shown in FIG. 5 and FIG. 6, the projection device 100 further includes a power circuit 50. The output terminal 51 of the power circuit 50 is connected to the fourth input terminal 23 of the first driving circuit 20, and the power circuit 50 is configured to supply a first voltage V1 to the first driving circuit 20, such that the first driving circuit 20 outputs the first current I1 under the drive of the first voltage VI. The power circuit 50 includes an alternating current-direct current (AC-DC) converter. The power circuit 50 may also be replaced with a battery or another energy-supplying device, which is not limited in the present disclosure.

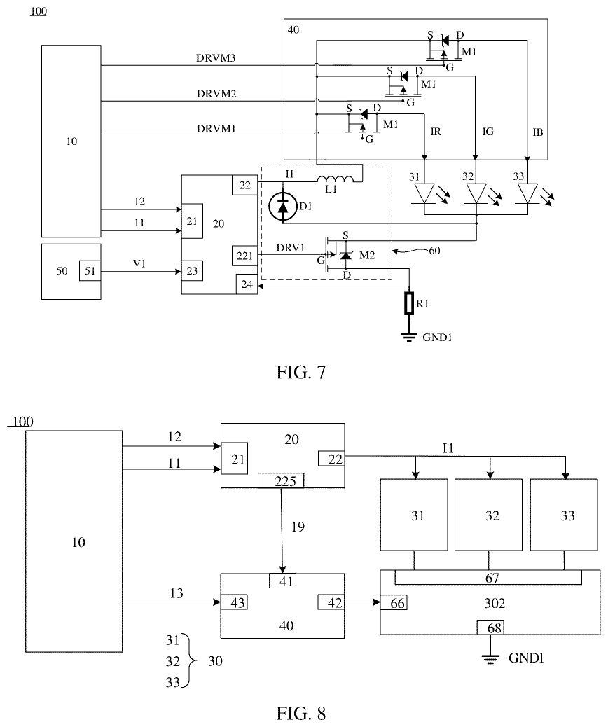

FIG. 7 is another circuit diagram of a projection device according to some embodiments. In some embodiments, as shown in FIG. 7, the projection device 100 further includes a first circuit 60. The first circuit 60 is connected to the first output terminal 22 and the second output terminal 221 of the first driving circuit 20, the first terminal 41 of the first switching circuit 40, and the second terminals of the plurality of light sources 30. The first circuit 60 is configured to regulate the first current I1.

For example, the first circuit 60 includes a first inductor L1, a first diode D1 and a second transistor M2. The first terminal of the first inductor L1 is connected to the first output terminal 22 of the first driving circuit 20 and the first terminal of the first diode D1, and the second terminal of the first inductor L1 is connected to the first terminal 41 of the first switching circuit 40. The first inductor L1 is configured to store part of the current output by the first driving circuit 20 in the form of electrical energy. The second terminal of the first diode D1 is connected to the second terminals of the plurality of light sources 30 and the first terminal of the second transistor M2. The gate G of the second transistor M2 is connected to the second output terminal 221 of the first driving circuit 20, and the second terminal of the second transistor M2 is connected to the first grounding terminal GND1.

The first terminal of the first diode D1 is a cathode, and the second terminal of the first diode D1 is an anode. The second transistor M2 may also be a P-type MOSFET. The first terminal of the second transistor M2 is a source S, and the second terminal of the second transistor M2 is a drain D.

In the case where the first circuit 60 includes the first inductor L1, the first diode D1 and the second transistor M2, the first driving circuit 20 is further configured to output a first signal DRV1 to the gate G of the second transistor M2 when the first driving circuit 20 outputs the first current I1 to the first transistor M1 corresponding to the target light source. Here, the first signal DRV1 may be a PWM signal.

For example, when the first signal DRV1 output by the first driving circuit 20 to the gate G of the second transistor M2 is at a low level, the source S and the drain D of the second transistor M2 are turned on. At this time, the first diode D1 is in an off state, and the connection between the first driving circuit 20 and the first grounding terminal GND1 is turned on to enable the light source 30 to emit light. Therefore, when the second transistor M2 is in the on state, the first inductor L1 is in a charging state.

When the first signal DRV1 output by the first driving circuit 20 to the gate G of the second transistor M2 is at a high level, the source S and the drain D of the second transistor M2 are turned off. At this time, the first diode D1 is in an on state, and the first inductor L1 is in a discharging state. Therefore, when the second transistor M2 is in the off state, the electrical energy discharged by the first inductor L1 drives the light source 30 to emit light continuously, which can increase the light-emitting stability of the light source 30.

Therefore, the first driving circuit 20 can change the turn-on duration of the second transistor M2 by adjusting the duty ratio of the output first signal DRV1. When the duty ratio of the first signal DRV1 is large per unit time (e.g., 1 second), the turn-off duration of the second transistor M2 per unit time is longer, and the driving current flowing through the light source 30 is also smaller. When the duty ratio of the first signal DRV1 is smaller per unit time, the turn-on duration of the second transistor M2 per unit time is longer, and the current flowing through the light source 30 is also larger. Therefore, by adjusting the duty ratio of the first signal DRV1, the current flowing through the light source 30 can be regulated, and the rated current required for each light source 30 in the plurality of light sources 30 can be obtained more easily.

In some embodiments, as shown in FIG. 7, the projection device 100 further includes a first sampling resistor R1. The first terminal of the first sampling resistor R1 is connected to the first circuit 60 and the fifth input terminal 24 of the first driving circuit 20, and the second terminal of the first sampling resistor R1 is connected to the first grounding terminal GND1. The first sampling resistor R1 is configured to sample the first current I1, so that the first driving circuit 20 receives, through the fifth input terminal 24, the first current I1 sampled by the first sampling resistor R1.

It should be noted that the rated current of the light source 30 may be pre-stored in the first driving circuit 20. In this way, the first driving circuit 20 can adjust the duty ratio of the first signal DRV1 based on the sampled first current I1 and the pre-stored rated current. For example, when the first current I1 sampled by the first sampling resistor R1 is less than the rated current, the first driving circuit 20 reduces the duty ratio of the first signal DRV1 so as to increase the turn-on duration of the second transistor M2, thereby increasing the first current I1 flowing through the light source 30. When the first current I1 sampled by the first sampling resistor R1 is greater than the rated current, the first driving circuit 20 increases the duty ratio of the first signal DRV1 so as to reduce the turn-on duration of the second transistor M2, thereby reducing the first current I1 flowing through the light source 30.

In the projection device 100 provided in some embodiments of the present disclosure, the projection device 100 only needs one control circuit 10, one first driving circuit 20 and one first switching circuit 40 in order to achieve the sequential light emission of the plurality of light sources 30 of different colors. Furthermore, the projection device 100 only needs one first circuit 60 to regulate the current flowing through three light sources 30. Moreover, the projection device 100 only needs one first sampling resistor R1 to sample the current flowing through three light sources 30. Compared with the projection device 1000 in the related art, at least two first driving circuits, two first diodes, two first inductors and two first sampling resistors are saved in the projection device 100 provided in the present disclosure. Therefore, the structure of the circuit board controlling the light sources 30 in the projection device 100 is simplified and the cost is reduced. The structure of the circuit board controlling the light sources 30 in the projection device 100 is relatively simpler and has a smaller area, which facilitates the integration of the circuit board and the light sources 30 and is beneficial for the miniaturization of the projection device 100.

Additionally, in the projection device 100 provided in some embodiments of the present disclosure, only one second transistor M2 is in a high-speed on and off state, which can effectively reduce the heat and electromagnetic radiation generated by the control circuit 10 during the process of regulating the driving current output by the first driving circuit 20. Therefore, the heat dissipation device (such as heat sink) and the devices used to shield electromagnetic radiation (such as magnetic rings) can be omitted in the projection device 100, thereby simplifying the structure and reducing the cost of the projection device 100.

The above descriptions of the projection device 100 are provided by taking an example where the switching circuit (i.e., the first switching circuit 40) controls the turn-on and turn-off of the wire between the plurality of light sources 30 and the first driving circuit 20 to control the plurality of light sources 30 to emit light at different times. In some embodiments, in the projection device 100, the light emission of the plurality of light sources 30 at different times may also be achieved by controlling the turn-on and turn-off of the wire between the plurality of light sources 30 and the first grounding terminal GND1.

FIG. 8 is another circuit diagram of a projection device according to some embodiments. For example, as shown in FIG. 8, the projection device 100 includes a control circuit 10, a first driving circuit 20, a plurality of light sources 30, a first switching circuit 40 and a second switching circuit 302. The plurality of light sources 30 include a first light source 31, a second light source 32 and a third light source 33. For the structure of control circuit 10, reference may be made to the description above, which is not repeated any further.

The control circuit 10 is configured to output a first enable signal 11 and at least one first driving signal 12 to the first driving circuit 20 and output at least one first switching signal 13 to the first switching circuit 40 based on the light emission information of the plurality of light sources 30.

The first input terminal 21 of the first driving circuit 20 is connected to the control circuit 10, the first output terminal 22 of the first driving circuit 20 is connected to the first terminals of the plurality of light sources 30, and the third output terminal 225 of the first driving circuit 20 is connected to the first terminal of the first switching circuit 40. The first driving circuit 20 is further configured to output a second switching signal 19 to the first switching circuit 40 based on the first enable signal 11 and the at least one first driving signal 12.

The control terminal 43 of the first switching circuit 40 is connected to the control circuit 10, and the second terminal 42 of the first switching circuit 40 is connected to the control terminal 66 of the second switching circuit 302. The first switching circuit 40 is configured to transmit the second switching signal 19 to the second switching circuit 302 based on the first switching signal 13.

The first terminal 67 of the second switching circuit 302 is connected to the second terminals of the plurality of light sources 30, and the second terminal 68 of the second switching circuit 302 is connected to the first grounding terminal GND1. The second switching circuit 302 is configured to in sequence turn on the connection between the plurality of light sources 30 and the first grounding terminal GND1 based on the second switching signal 19 to drive the plurality of light sources 30 to emit light in sequence.

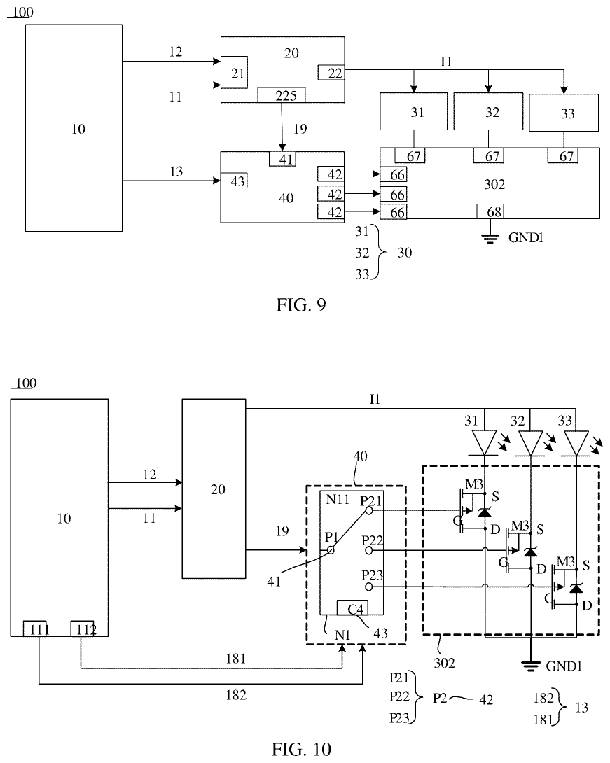

FIG. 9 is another circuit diagram of a projection device according to some embodiments.

In some embodiments, as shown in FIG. 9, the first switching circuit 40 includes a plurality of second terminals 42, and the second switching circuit 302 includes a plurality of first terminals 67 and a plurality of control terminals 66. The plurality of control terminals 66 are in one-to-one correspondence with the plurality of first terminals 67. The plurality of first terminals 67 of the second switching circuit 302 are respectively connected to the second terminals of the plurality of light sources 30, and the plurality of control terminals 66 of the second switching circuit 302 are respectively connected to the plurality of second terminals 42 of the first switching circuit 40.

The control circuit 10 is further configured to: based on the light emission information of the plurality of light sources 30, output a first switching signal 13 to the first switching circuit 40 to control the turn-on and turn-off of the first switching circuit 40. The turn-on and turn-off of the first switching circuit 40 refer to the turn-on and turn-off of the connection between the first terminal 41 of the first switching circuit 40 and one of the plurality of second terminals 42 of the first switching circuit 40.

When the first driving circuit 20 receives the first enable signal 11 and the first driving signal 12, the first driving circuit 20 outputs the second switching signal 19 to the first terminal 41 of the first switching circuit 40, and the first switching circuit 40 turns on, based on the first switching signal 13, the connection between the first terminal 41 of the first switching circuit 40 to one of the plurality of second terminals 42 of the first switching circuit 40. In this way, the first switching circuit 40 can transmit the received second switching signal 19 from the first terminal 41 to the second terminal 42, and then transmit the second switching signal 19 to the control terminal 66 of the second switching circuit 302.

When a control terminal 66 of the second switching circuit 302 receives the second switching signal 19, the second switching circuit 302 turns on the connection between the first terminal 67 corresponding to the control terminal 66 and the second terminal 68, so that the connection between the target light source in the plurality of light sources 30 and the first grounding terminal GND1 is turned on. In this way, the first current I1 output by the first driving circuit 20 flows through the turned-on light source 30 to the first grounding terminal GND1 to drive the turned-on light source 30 to emit light.

In some embodiments of the present disclosure, the first switching circuit 40 turns on the connection between the first terminal 41 of the first switching circuit 40 and one of the plurality of second terminals 42 of the first switching circuit 40 based on the first switching signal 13, to transmit the second switching signal 19 to the control terminal 66 of the second switching circuit 302 connected to the second terminal 42, such that the connection between the plurality of light sources 30 and the first grounding terminal GND1 is turned on in sequence, thereby driving the plurality of light sources 30 to emit light in sequence. Thus, the projection device 100 displays a projected image. Furthermore, the first driving circuit 20 drives only one of the plurality of light sources 30 to emit light in one period, which can prevent more than two light sources 30 of different colors from emitting light at the same time, thereby avoiding the color mixing problem of the plurality of light sources 30 during the light-emitting process and improving the display effect of the projected image.

It is further to be understood that the first switching circuit 40 and the second switching circuit 302 control the turn-on and turn-off of the connection between the first grounding terminal GND1 and any one of the plurality of light sources 30, and the projection device 100 can achieve the light emission of the plurality of different light sources 30 using only one first driving circuit 20. Therefore, the structure of projection device 100 is effectively simplified and the manufacturing cost of projection device 100 is reduced.

FIG. 10 is another circuit diagram of a projection device according to some embodiments. In some embodiments, as shown in FIG. 10, the first switching circuit 40 includes a single-pole multi-throw switch N1. As shown in FIG. 10, the single-pole multi-throw switch N1 includes a control terminal C4, a first terminal P1, and a plurality of second terminals P2. The control terminal C4 of the single-pole multi-throw switch N1 serves as the control terminal 43 of the first switching circuit 40, the first terminal P1 of the single-pole multi-throw switch N1 is the first terminal 41 of the first switching circuit 40, and the plurality of second terminals P2 of the single-pole multi-throw switch N1 are the plurality of second terminals 42 of the first switching circuit 40.

In some embodiments, as shown in FIG. 10, the first switching signal 13 includes a first sub-signal 181 and a second sub-signal 182, the single-pole multi-throw switch N1 is a single-pole three-throw switch N11, which includes the first terminal P1 and three second terminals P2. The three second terminals P2 include a first sub-terminal P21, a second sub-terminal P22 and a third sub-terminal P23. The single-pole three-throw switch N11 is configured to: transmit, in response to receiving the first sub-signal 181 of the second level and the second sub-signal 182 of the second level, the second switching signal 19 to a control terminal 66 corresponding to the first light source 31 in the second switching circuit 302; transmit, in response to receiving the first sub-signal 181 of the second level and the second sub-signal 182 of the first level, the second switching signal 19 to a control terminal 66 corresponding to the second light source 32 in the second switching circuit 302; and transmit, in response to receiving the first sub-signal 181 of the first level and the second sub-signal 182 of the second level, the second switching signal 19 to a control terminal 66 corresponding to the third light source 33 in the second switching circuit 302.

The second level is a high level relative to the first level. This second level may be represented by a value “0”, and the first level may be represented by a value “1”. When the first sub-signal 181 and the second sub-signal 182 are respectively at the second signals, the first switching signal 13 received by the first switching circuit 40 may be expressed as “00”. When the first sub-signal 181 is at the second level and the second sub-signal 182 is at the first level, the first switching signal 13 received by the first switching circuit 40 may be expressed as “01”. When the first sub-signal 181 is at the first level and the second sub-signal 182 is at the second level, the first switching signal 13 received by the first switching circuit 40 may be expressed as “10”.

For example, when the single-pole three-throw switch N11 receives the first sub-signal 181 of the second level and the second sub-signal 182 of the second level, the connected between the first terminal P1 and the first sub-terminal P21 is turned on, and the second switching signal 19 is transmitted to the control terminal 66 connected to the first sub-terminal P21. When the single-pole three-throw switch N11 receives the first sub-signal 181 of the second level and the second sub-signal 182 of the first level, the connected between the first terminal P1 and the second sub-terminal P22 is turned on, and the second switching signal 19 is transmitted to the control terminal 66 connected to the second sub-terminal P22. When the single-pole three-throw switch N11 receives the first sub-signal 181 of the first level and the second sub-signal 182 of the second level, the connected between the first terminal P1 and the third sub-terminal P23 is turned on, and the second switching signal 19 is transmitted to the control terminal 66 connected to the third sub-terminal P23.

When the control terminal 66 corresponding to the first light source 31 in the second switching circuit 302 receives the second switching signal 19, the connected between the first light source 31 and the first grounding terminal GND1 is turned on, such that the first light source 31 emits light under the drive of the driving current. At this time, the second light source 32 and the third light source 33 stop emitting light. When the control terminal 66 corresponding to the second light source 32 in the second switching circuit 302 receives the second switching signal 19, the connected between the second light source 32 and the first grounding terminal GND1 is tuned on, such that the second light source 32 emits light under the drive of the driving current. At this time, the first light source 31 and the third light source 33 stop emitting light. When the control terminal 66 corresponding to the third light source 33 in the second switching circuit 302 receives the second switching signal 19, the connected between the third light source 33 and the first grounding terminal GND1 is turned on, such that the third light source 33 emits light under the drive of the driving current. At this time, the first light source 31 and the second light source 32 stop emitting light.

In some embodiments, as shown in FIG. 10, the second switching circuit 302 comprises a plurality of third transistors M3, and the plurality of third transistors M3 are in one-to-one correspondence with the plurality of light source 30. The gates G of the plurality of third transistors M3 are the plurality of control terminal 66 of the second switching circuit 302, the first terminals of the plurality of third transistors M3 are the plurality of first terminals 67 of the second switching circuit 302, and the second terminals of the plurality of third transistors M3 are the second terminal 68 of the second switching circuit 302.

The plurality of third transistors M3 may be P-type metal oxide semiconductor (MOS) transistors respectively. Furthermore, the first electrodes of the third transistors M3 are sources(S) respectively, and the second electrodes of the third transistors M3 are drains (D) respectively.

In the case where the second switching circuit 302 includes a plurality of third transistors M3, and the plurality of third transistors M3 are in one-to-one correspondence with the plurality of light source 30, the control circuit 10 is further configured to control, during the period of outputting the first driving signal 12 corresponding to one light source 30 in the plurality of light sources 30, the connection between the light source 30 and the corresponding third transistor M3 to be turned on.

When one third transistor M3 in the second switching circuit 302 receives the second switching signal 19, the third transistor M3 turns on the source S and the drain D thereof based on the second switching signal 19, such that the connection between the light source 30 connected to the third transistor M3 and the first grounding terminal GND1 is turned on. In this way, the first current I1 can flow through the turned-on light source 30 to the first grounding terminal GND1, thereby driving the turned-on light source 30 to emit light. Furthermore, in the second switching circuit 302, the source S and the drain D of the third transistor M3 that does not receive the second switching signal 19 are turned off.

It should be noted that the turn-on duration of the source S and the drain D of the third transistor M3 corresponding to the target light source is set light-emitting duration of the target light source. In the case where the control circuit 10 determines that the turn-on duration of the source S and the drain D of the third transistor M3 corresponding to the target light source reaches the set light-emitting duration of the target light source, the control circuit 10 turns off the third transistor M3 corresponding to the target light source by controlling the turn-on and turn-off of the single-pole multi-throw switch N1, such that the target light source stops emitting light. Furthermore, the control circuit 10 may also turn on the third transistor M3 corresponding to another light source 30 (i.e., another target light source) by controlling the turn-on and turn-off of the single-pole multi-throw switch N1, thereby driving the other light source 30 to emit light.

In some embodiments, the control circuit 10 is further configured to turn on, by controlling the single-pole multi-throw switch N1, the connection between the first driving circuit 20 and the third transistor M3 corresponding to another light source 30 in the plurality of light sources 30 to be turned on if the third transistor M3 corresponding to the target light source stops receiving the second switching signal 19 for a first target duration. Here, the first target duration is determined based on needs.

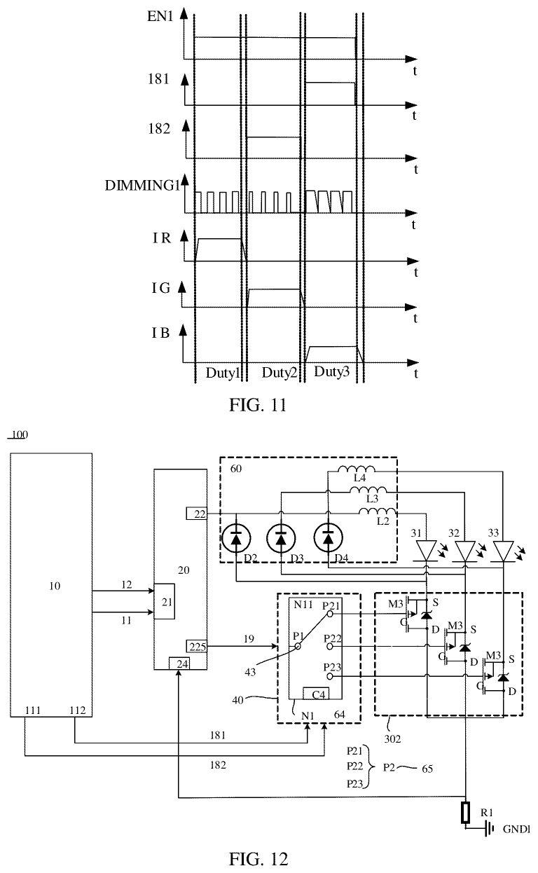

FIG. 11 is another waveform diagram of a plurality of signals according to some embodiments. In FIG. 11, EN1 represents the first enable signal 11 and DIMMING1 represents the first driving signal 12. The first driving current IR represents the first current I1 output by the first driving circuit 20 to the first light source 31. The second driving current IG represents the first current I1 output by the first driving circuit 20 to the second light source 32. The third driving current IB represents the first current I1 output by the first driving circuit 20 to the third light source 33.

Taking an example where the first light source 31 emits red light beams, the second light source 32 emits green light beams, and the third light source 33 emits blue light beams, as shown in FIG. 11, when the control circuit 10 is powered on and started, the control circuit 10 first outputs a first enable signal 11 of a third level and the first driving signal 12 corresponding to the first light source 31 to the first driving circuit 20. The control circuit 10 also outputs a first sub-signal 181 of a second level and a second sub-signal 182 of the second level to the single-pole multi-throw switch N1, such that the connection between the first terminal P1 and the first sub-terminal P21 is turned on, and then the second switching signal 19 is transmitted to the third transistor M3 corresponding to the first light source 31. The third transistor M3 is turned on under the control of the second switching signal 19, such that the connection between the first light source 31 and the first grounding terminal GND1 is turned on. In this way, the first current I1 drives the first light source 31 to emit light. At this time, the second light source 32 and the third light source 33 stop emitting light.

When the light-emitting duration of the first light source 31 reaches the first light-emitting duration Duty1, the control circuit 10 stops outputting the first driving signal 12 corresponding to the first light source 31 to the first driving circuit 20. At this time, the first light source 31 stops emitting light.

When the first light source 31 stops emitting light for the first target duration, the control circuit 10 outputs the first driving signal 12 corresponding to the second light source 32 to the first driving circuit 20. The control circuit 10 also outputs a first sub-signal 181 of a second level and a second sub-signal 182 of a first level to the single-pole multi-throw switch N1, such that the connection between the first terminal P1 and the second sub-terminal P22 is turned on, and then the second switching signal 19 is transmitted to the third transistor M3 corresponding to the second light source 32. The third transistor M3 is turned on under the control of the second switching signal 19, and thus the connection between the second light source 32 and the first grounding terminal GND1 is turned on. In this way, the second current I2 drives the second light source 32 to emit light. At this time, the first light source 31 and the third light source 33 stop emitting light.

When the light-emitting duration of the second light source 32 reaches the second light-emitting duration Duty2, the control circuit 10 stops outputting the first switching signal 13 corresponding to the second light source 32 to the first driving circuit 20. At this time, the second light source 32 stops emitting light.

When the second light source 32 stops emitting light for the first target duration, the control circuit 10 outputs the first driving signal 12 corresponding to the third light source 33 to the first driving circuit 20. The control circuit 10 also outputs the first sub-signal 181 of the first level and the second sub-signal 182 of the second level to the single-pole multi-throw switch N1, such that the connection between the first terminal P1 and the third sub-terminal P23 is turned on, and then the second switching signal 19 is transmitted to the third transistor M3 corresponding to the third light source 33. The third transistor M3 is turned on under the control of the second switching signal 19, and thus the connection between the third light source 33 and the first grounding terminal GND1 is turned on. In this way, the first current I1 drives the third light source 33 to emit light. At this time, the first light source 31 and the second light source 32 stop emitting light.

When the light-emitting duration of the third light source 33 reaches the third light-emitting duration Duty3, the control circuit 10 outputs a first enable signal 11 of a fourth level to the first driving circuit 20 and stops outputting the first driving signal 12 corresponding to the third light source 33 to the first driving circuit 20. At this time, the third light source 33 stops emitting light. Here, the fourth level is a low level relative to the third level.

FIG. 12 is another circuit diagram of a projection device according to some embodiments. In some embodiments, as shown in FIG. 12, the projection device 100 further includes a first circuit 60. The first circuit 60 is connected to the first output terminal 22 of the first driving circuit 20 and the first terminals of the plurality of light sources 30, and the first circuit 60 is configured to regulate the first current I1. The first circuit 60 includes a second inductor L2, a second diode D2, a third inductor L3, a third diode D3, a fourth inductor L4 and a fourth diode D4. The first terminal of the second inductor L2 is connected to the first output terminal 22 of the first driving circuit 20 and the first terminal of the second diode D2, and the second terminal of the second inductor L2 is connected to the first terminal of the first light source 31. The second terminal of the second diode D2 is connected to the second terminal of the first light source 31 and one of the plurality of first terminals 67 of the second switching circuit 302.

The first terminal of the third inductor L3 is connected to the first output terminal 22 of the first driving circuit 20 and the first terminal of the third diode D3, and the second terminal of the third inductor L3 is connected to the first terminal of the second light source 32. The second terminal of the third diode D3 is connected to the second terminal of the second light source 32 and another one of the plurality of first terminals 67 of the second switching circuit 302.

The first terminal of the fourth inductor L4 is connected to the first output terminal 22 of the first driving circuit 20 and the first terminal of the fourth diode D4, and the second terminal of the fourth inductor L4 is connected to the first terminal of the third light source 33. The second terminal of the fourth diode D4 is connected to the second terminal of the third light source 33 and still another one of the plurality of first terminals of the second switching circuit 302.

It should be noted that the first terminals of the second diode D2, third diode D3 and fourth diode D4 are cathodes respectively, and the second terminals of the second diode D2, third diode D3 and fourth diode D4 are anodes respectively. The principles of the second inductor L2, third inductor L3, and fourth inductor L4 are similar to the principle of the first inductor L1, which are not repeated any further. Furthermore, the third transistor M3 plays a similar function to the second transistor M2 to regulate the first current I1 flowing through the plurality of light sources 30, thereby improving the utilization rate of the plurality of third transistors M3. In addition, since the projection device 100 can achieve the light emission switching of the plurality of light sources 30 only through the single-pole multi-throw switch N1 and the three third transistors M3, the structure of the projection device 100 is effectively simplified and the cost of the projection device 100 is reduced.

In some embodiments, as shown in FIG. 12, the projection device 100 further includes a first sampling resistor R1. The first terminal of the first sampling resistor R1 is connected to the second terminal 68 of the second switching circuit 302 and the fifth input terminal 24 of the first driving circuit 20, and the second terminal of the first sampling resistor R1 is connected to the first grounding terminal GND1. For the function of the first sampling resistor R1, reference may be made to the descriptions above, which is not repeated any further.

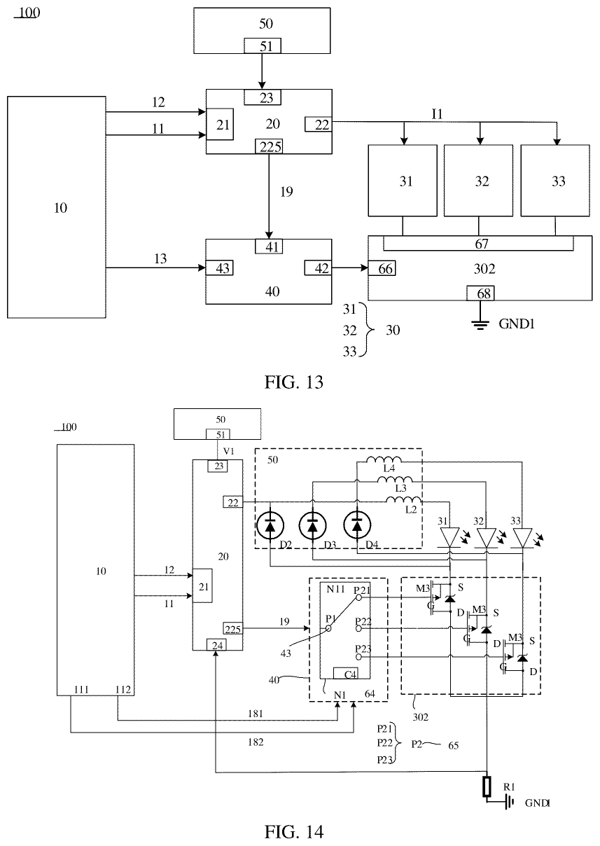

FIG. 13 is another circuit diagram of a projection device according to some embodiments, and FIG. 14 is another circuit diagram of a projection device according to some embodiments. In some embodiments, as shown in FIG. 13 and FIG. 14, the projection device 100 further includes a power circuit 50. The output terminal 51 of the power circuit 50 is connected to the fourth input terminal 23 of the first driving circuit 20. For the function and principle of the power circuit 50, reference may be made to the descriptions above, which are not repeated any further.

The above descriptions are provided by taking an example where the projection device 100 includes one driving circuit (i.e., the first driving circuit 20). In some embodiments, the projection device 100 may also include two driving circuits.

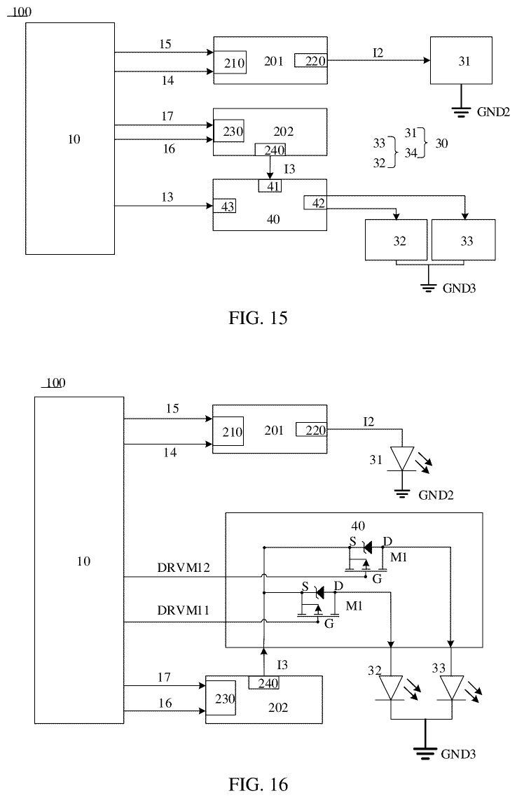

FIG. 15 is a circuit diagram of a projection device according to some embodiments. As shown in FIG. 15, the projection device 100 includes a control circuit 10, a second driving circuit 201, a third driving circuit 202, a first switching circuit 40, and a plurality of light sources 30. For the structure of the control circuit 10, reference may be made to the descriptions above, which is not repeated any further.

The plurality of light sources 30 are of different colors, and each of the light sources 30 is a laser. For example, the plurality of light sources 30 include a first light source 31 and a plurality of fourth light sources 34. The first light source 31 and the plurality of fourth light sources 34 are of different colors from each other. For example, the plurality of fourth light sources 34 include a second light source 32 and a third light source 33. For example, the first light source 31 emits red laser light, the second light source 32 emits green laser light, and the third light source 33 emits blue laser light. The plurality of light sources 30 may also emit laser light of other colors, which is not limited in the present disclosure.

The control circuit 10 is configured to: based on the light emission information of the plurality of light sources 30, output a second enable signal 14 and a second driving signal 15 to the second driving circuit 201, output a third enable signal 16 and at least one third driving signal 17 to the third driving circuit 202, and output at least one first switching signal 13 to the first switching circuit 40.

The first input terminal 210 of the second driving circuit 201 is connected to the control circuit 10, and the first output terminal 220 of the second driving circuit 201 is connected to the first terminal of the first light source 31. The second terminal of the first light source 31 is connected to a second grounding terminal GND2. The second driving circuit 201 is configured to output a second current I2 to the first light source 31 based on the second enable signal 14 and the second driving signal 15, to drive the first light source 31 to emit light.

The first input terminal 230 of the third driving circuit 202 is connected to the control circuit 10. The third driving circuit 202 is configured to output a third current I3 based on the third enable signal 16 and the at least one third driving signal 17 to drive one of a plurality of second light sources 32 to emit light.

The control terminal 43 of the first switching circuit 40 is connected to the control circuit 10, the first terminal 41 of the first switching circuit 40 is connected to the first output terminal 240 of the third driving circuit 202, the second terminal 42 of the first switching circuit 40 is connected to the first terminals of the plurality of fourth light sources 34, and the second terminals of the plurality of fourth light sources 34 are connected to a third grounding terminal GND3. The first switching circuit 40 is configured to in sequence turn on the connection between the third driving circuit 202 and the plurality of fourth light sources 34 based on the at least one first switching signal 13, to drive the plurality of fourth light sources 34 to emit light in sequence, such that the projection device 100 displays a projected image. Here, the sequential light emission of the plurality of fourth light sources 34 refers to that the light-emitting periods of the plurality of fourth light sources 34 are staggered from each other.

When the projection device 100 is powered on and started, the control circuit 10 outputs a first switching signal 13 to the first switching circuit 40 based on the light emission information of the plurality of light sources 30, to control the turn-on or turn-off of the first switching circuit 40. The turn-on or turn-off of the first switching circuit 40 refers to the turn-on or turn-off of the connection between the first terminal 41 of the first switching circuit 40 and the second terminal 42 of the first switching circuit 40. The control circuit 10 also transmits the second enable signal 14 and the second driving signal 15 to the second driving circuit 201 and outputs the third enable signal 16 and the third driving signal 17 to the third driving circuit 202 based on the light emission information of the plurality of light sources 30.

When the second driving circuit 201 receives the second enable signal 14, the second driving circuit 201 outputs or stops outputting the second current I2. When the third driving circuit 202 receives the third enable signal 16, the second driving circuit 201 outputs or stops outputting the third current I3. When the second driving circuit 201 receives the second driving signal 15, the second driving circuit 201 determines the magnitude of the second current I2 based on the second driving signal 15. When the third driving circuit 202 receives the third driving signal 17, the third driving circuit 202 determines the magnitude of the third current I3 based on the third driving signal 17. The second driving signal 15 and the third driving signal 17 are PWM signals. For the working principle of the PWM signal, reference may be made to the above descriptions of the first driving signal 12.

When the first switching circuit 40 receives the first switching signal 13, the first switching circuit 40 turns on the connection between the third driving circuit 202 and one of the plurality of fourth light sources 34. In this way, the third current I3 is transmitted to the turned-on fourth light source 34.

It should be noted that the second current I2 can directly drive the first light source 31 to emit light, and the third current I3 needs to be transmitted to one fourth light source 34 that is conducted with the third grounding terminal GND3 under the control of the third driving circuit 202 and the first switching circuit 40.

In some embodiments, the light-emitting periods of the first light source 31 and the plurality of fourth light sources 34 are staggered from each other. For example, the control circuit 10 first outputs the second enable signal 14 and the second driving signal 15 to the second driving circuit 201 to drive the first light source 31 to emit light. After the light-emitting duration of the first light source 31 reaches the first light-emitting duration Duty1, the control circuit 10 outputs the third enable signal 16 and the third driving signal 17 to the third driving circuit 202 and outputs the first switching signal 13 to the first switching circuit 40, such that the third driving circuit 202 drives the plurality of fourth light sources 34 to emit light in sequence. The first light-emitting duration Duty1 represents the set light-emitting duration of the first light source 31.

In some embodiments, when the control circuit 10 outputs the second enable signal 14 and the second driving signal 15 to the second driving circuit 201, the control circuit 10 further outputs the third enable signal 16 and the third driving signal 17 to the third driving circuit 202. At this time, the first light source 31 emits light simultaneously with one fourth light source in the plurality of fourth light sources 34. In this way, the light beam emitted by the first light source 31 and the light beam emitted by the fourth light source 34 form a light beam of a new color. For example, if the first light source 31 emits a green light beam and the fourth light source 34 emits a red light beam, then the green light beam and the red light beam form a yellow light beam. For another example, if the first light source 31 emits a green light beam and the fourth light source 34 emits a blue light beam, then the green light beam and the blue light beam form a cyan light beam.

The brightness of the light beam formed by the light beams emitted by two light sources of different colors 30 is higher than brightness of the light beam emitted by a single light source 30. Therefore, during the process of displaying a projected image by the projection device 100, the control circuit 10 drives, through the second driving circuit 201 and the third driving circuit 202, the first light source 31 and one fourth light source 34 to emit light simultaneously, which can make the brightness of the projected image projected by the projection device 100 higher. Thus, the display effect of the projected image is improved.

In some embodiments of the present disclosure, the first switching circuit 40 controls, based on the first switching signal 13, the turn-on and turn-off of the connection between the third driving circuit 202 and each one of the plurality of fourth light sources 34. In this way, the plurality of light sources 30 emitting light of different colors from each other can be emit light in sequence through the second driving circuit 201 and the third driving circuit 202 only. The structure of projection device 100 is effectively simplified and the manufacturing cost is reduced.

FIG. 16 is another circuit diagram of a projection device according to some embodiments. In some embodiments, as shown in FIG. 16, the first switching circuit 40 includes a plurality of first transistors M1, and the plurality of first transistors M1 correspond to the plurality of fourth light sources 34 respectively. The gates G of the plurality of first transistors M1 serve as the control terminal 43 of the first switching circuit 40, the first electrodes of the plurality of first transistors M1 serve as the first terminal 41 of the first switching circuit 40, and the second electrodes of the plurality of first transistors M1 serve as the second terminal 42 of the first switching circuit 40.

In some embodiments, the at least one first switching signal 13 includes a plurality of first switching signals 13, and the plurality of first switching signals 13 correspond to the plurality of fourth light sources 34 respectively. In the case where the first switching circuit 40 includes a plurality of first transistors M1, the control circuit 10 is further configured to output a plurality of first switching signals 13 to the gates G of the plurality of first transistors M1 to control the turn-on and turn-off of the connection between the third driving circuit 202 and each of the plurality of fourth light sources 34.

In the case where the first switching circuit 40 includes a plurality of first transistors M1, the control circuit 10 is further configured to output the corresponding first switching signals 13 to the gates G of the plurality of first transistors M1 respectively. After receiving the first switching signal 13, each first transistor M1 controls the turn-on and turn-off of the connection between the third driving circuit 202 and each of the fourth light sources 34. For example, the first switching signal 13 includes a first sub-switching signal of a first level and a second sub-switching signal of a second level. When the first transistor M1 receives the first sub-switching signal, the first transistor M1 turns on the connection between the third driving circuit 202 and the fourth light source 34 corresponding to the first transistor M1. When the first transistor M1 receives the second sub-switching signal, the first transistor M1 turns off the connection between the third driving circuit 202 and the fourth light source 34 corresponding to the first transistor M1.

In some embodiments, the control circuit 10 is further configured to: based on the light emission information of the plurality of light sources 30, output the first sub-switching signal of the first level to the gate G of the first transistor M1 corresponding to a target fourth light source, output the second sub-switching signal of the second level to the gate G of the first transistor M1 corresponding to another fourth light source 34, and output the third driving signal 17 corresponding to the target fourth light source to the third driving circuit 202. The target fourth light source is a fourth light source 34 that currently needs to emit light as determined by the control circuit 10 based on the light emission information of the plurality of light sources.

In this case, the third driving circuit 202 is further configured to: transmit the third current I3 to the sources S of the plurality of first transistors M1 based on the third driving signal 17 corresponding to the target fourth light source. After the gate G of the first transistor M1 corresponding to the target fourth light source receives the first sub-switching signal, the source S and drain D of the first transistor M1 are turned on. The third current I3 output by the third driving circuit 202 can drive the target fourth light source to emit light. At this time, the other fourth light sources 34, except the target fourth light source, in the plurality of fourth light sources 34 stop emitting light.

In some embodiments, the control circuit 10 is further configured to output the second sub-switching signal to the gate G of the first transistor M1 corresponding to the target fourth light source to turn off the source S and drain D of the first transistor M1, such that the target fourth light source stops emitting light.

In the case where the control circuit 10 determines that the turn-on duration of the first transistor M1 corresponding to the target second light source reaches the set light-emitting duration of the target fourth light source, the control circuit 10 outputs the second sub-switching signal to the gate G of the first transistor M1. The turn-on duration of the source S and drain D of the first transistor M1 corresponding to the target fourth light source may be the set light-emitting duration of the target fourth light source. Furthermore, the control circuit 10 outputs the first sub-switching signal to the gate G of the first transistor M1 corresponding to another fourth light source 34 in plurality of light sources 30, and outputs the third driving signal 17 corresponding to the another fourth light source 34 to the third driving circuit 202. The another fourth light source 34 is a next fourth light source 34 that needs to emit light after the light-emitting duration of the target fourth light source reaches the set light-emitting duration.

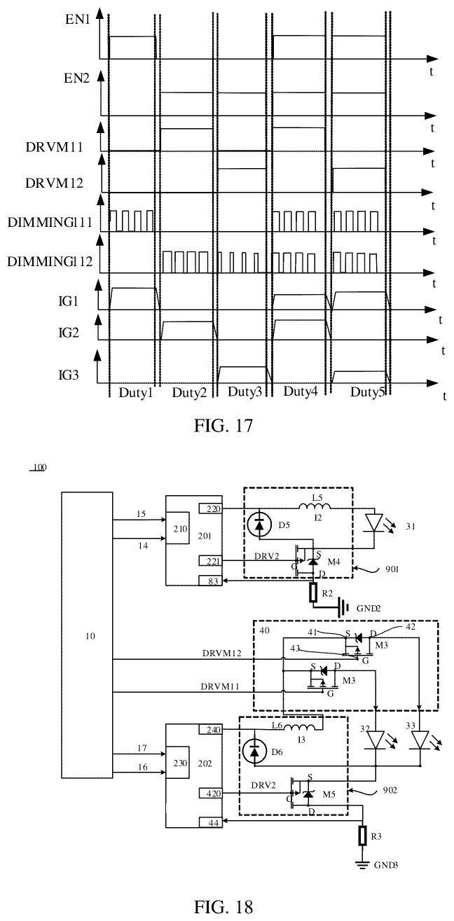

FIG. 17 is another waveform diagram of a plurality of signals according to some embodiments. In FIG. 17, EN1 represents the second enable signal 14, EN2 represents the third enable signal 16, DIMMING111 represents the second driving signal 15, DIMMING112 represents the third driving signal 17, and the first light-emitting duration Duty1 represents the set light-emitting duration of the first light source 31. The second light-emitting duration Duty2 represents the set light-emitting duration of the second light source 32, and the third light-emitting duration Duty3 represents the set light-emitting duration of the third light source 33. The fourth light-emitting duration Duty4 represents a corresponding set light-emitting duration when the first light source 31 and the second light source 32 light emit simultaneously. The fifth light-emitting duration Duty5 represents a corresponding set light-emitting duration when the first light source 31 and the third light source 33 light emit simultaneously. DRVM111 represents the first switching signal 13 output by the control circuit 10 to the gate G of the first transistor M1 corresponding to the second light source 32. DRVM112 represents the first switching signal 13 output by the control circuit 10 to the gate G of the first transistor M1 corresponding to the third light source 33. The fourth driving current IG1 represents the second current I2 output by the second driving circuit 201 to the first light source 31. The fifth driving current IG2 represents the third current I3 output by the third driving circuit 202 to the second light source 32. The sixth driving current IG3 represents the third current I3 output by the third driving circuit 202 to the third light source 33.

For example, as shown in FIG. 16 and FIG. 17, when the control circuit 10 is powered on and started, the control circuit 10 outputs the second enable signal 14 of the third level and the second driving signal 15 to the second driving circuit 201. The second driving circuit 201 outputs the second current I2 to the first light source 31 to drive the first light source 31 to emit light. At this time, the plurality of fourth light sources 34 stop emitting light.

When the light-emitting duration of the first light source 31 reaches the first light-emitting duration Duty1, the control circuit 10 outputs the second enable signal 14 of the fourth level to the second driving circuit 201 and stops outputting the second driving signal 15. At this time, the first light source 31 stops emitting light. Here, the third level is a high level relative to the fourth level. When the first light source 31 stops emitting light for a second target duration, the control circuit 10 outputs the third enable signal 16 of the third level and the third driving signal 17 corresponding to the second light source 32 to the third driving circuit 202, and outputs the first sub-switching signal of the first level to the gate G of the first transistor M1 corresponding to the second light source 32. At this time, the first transistor M1 turns on the connection between the third driving circuit 202 and the second light source 32, such that the third current I3 output by the third driving circuit 202 can drive the second light source 32 to emit light.

When the light-emitting duration of the second light source 32 reaches the second light-emitting duration Duty2, the control circuit 10 outputs the third enable signal 16 of the fourth level to the third driving circuit 202, stops outputting the third driving signal 17 corresponding to the second light source 32, and outputs the second sub-switching signal of the second level to the gate G of the first transistor M1 corresponding to the second light source 32. At this time, the second light source 32 stops emitting light. After the second light source 32 stops emitting light for the second target duration, the control circuit 10 inputs the third enable signal 16 of the third level and the third driving signal 17 corresponding to the third light source 33 to the third driving circuit 202, and outputs the first sub-switching signal of the first level to the gate G of the first transistor M1 corresponding to the third light source 33. At this time, the first transistor M1 turns on the connection between the third driving circuit 202 and the third light source 33, such that the third current I3 output by the third driving circuit 202 can drive the third light source 33 to emit light.

When the light-emitting duration of the third light source 33 reaches the third light-emitting duration Duty3, the control circuit 10 outputs the third enable signal 16 of the fourth level to the third driving circuit 202, stops outputting the third driving signal 17 corresponding to the third light source 33, and outputs the second sub-switching signal of the second level to the gate G of the first transistor M1 corresponding to the third light source 33. At this time, the fourth light source 34 stops emitting light.

If the projection device 100 needs to increase the brightness of the projected image, the second driving circuit 201 and the third driving circuit 202 can output currents simultaneously, such that the first light source 31 and one of the plurality of fourth light sources 34 emit light simultaneously.

For example, as shown in FIG. 17, in the case where the control circuit 10 determines that the third light source 33 stops emitting light for the second target duration, the control circuit 10 outputs the second enable signal 14 of the third level and the second driving signal 15 to the second driving circuit 201, outputs the third enable signal 16 of the third level and the third driving signal 17 corresponding to the second light source 32 to the third driving circuit 202, and outputs the first sub-switching signal of the first level to the gate G of the first transistor M1 corresponding to the second light source 32. At this time, the first light source 31 and the second light source 32 emit light simultaneously. For example, the light beams emitted by the first light source 31 and the second light source 32 are mixed to form a yellow light beam.

When the light-emitting durations of the first light source 31 and the light-emitting duration of the second light source 32 reach the fourth light-emitting duration Duty4, the control circuit 10 outputs the second enable signal 14 of the fourth level to the second driving circuit 201, stops outputting the second driving signal 15 corresponding to the first light source 31, outputs the third enable signal 16 of the fourth level to the third driving circuit 202, stops outputting the third driving signal 17 corresponding to the second light source 32, and outputs the second sub-switching signal of the second level to the gate G of the first transistor M1 corresponding to the second light source 32. At this time, the first light source 31 and the third light source 33 stop emitting light, respectively.

In the case where the control circuit 10 determines that the first light source 31 and the second light source 32 stop emitting light for the second target duration, the control circuit 10 outputs the second enable signal 14 of the third level and the second driving signal 15 to the second driving circuit 201, outputs the third enable signal 16 of the third level and the third driving signal 17 corresponding to the third light source 33 to the third driving circuit 202, and outputs the first sub-switching signal of the first level to the gate G of the first transistor M1 corresponding to the third light source 33. At this time, the first light source 31 and the third light source 33 emit light simultaneously. For example, the light beams emitted by the first light source 31 and the third light source 33 are mixed to form a purple light beam.

When the light-emitting duration of the first light source 31 and the light-emitting duration of the third light source 33 reach the fifth light-emitting duration Duty5, the control circuit 10 outputs the second enable signal 14 of the fourth level to the second driving circuit 201, stops outputting the second driving signal 15 corresponding to the first light source 31, outputs the third enable signal 16 of the fourth level to the third driving circuit 202, stops outputting the third driving signal 17 corresponding to the third light source 33, and outputs the second sub-switching signal of the second level to the gate G of the first transistor M1 corresponding to the third light source 33. At this time, the first light source 31 and the third light source 33 stop emitting light.

It should be noted that the second target duration is determined based on needs. Furthermore, the time interval (e.g., time delay) between the light-emitting periods of two adjacent light sources 30 in the plurality of light sources 30 may be equal, which is not limited in the present disclosure.

FIG. 18 shows another circuit diagram of a projection device according to some embodiments. In some embodiments, as shown in FIG. 18, the projection device 100 further includes a second circuit 901 and a third circuit 902.

The second circuit 901 is connected to the first output terminal 220 and the second output terminal 221 of the second driving circuit 201 and the first light source 31. The second circuit 901 is configured to regulate the second current I2. The second circuit 901 includes a fifth inductor L5, a fifth diode D5, and a fourth transistor M4. The first terminal of the fifth inductor L5 is connected to the first output terminal 220 of the second driving circuit 201 and the first terminal of the fifth diode D5, and the second terminal of the fifth inductor L5 is connected to the first terminal of the first light source 31. The second terminal of the fifth diode D5 is connected to the second terminal of the first light source 31 and the first electrode of the fourth transistor M4. The gate G of the fourth transistor M4 is connected to the second output terminal 221 of the second driving circuit 201, and the second electrode of the fourth transistor M4 is connected to a second grounding terminal GND2.

The third circuit 902 is connected to the first output terminal 240 and the second output terminal 420 of the third driving circuit 202, the first terminal of the first switching circuit 40, and the second terminals of the plurality of fourth light sources 34. The third circuit 902 is configured to regulate the third current I3. The third circuit 902 includes a sixth inductor L6, a sixth diode D6, and a fifth transistor M5. The first terminal of the sixth inductor L6 is connected to the first output terminal 240 of the third driving circuit 202 and the first terminal of the sixth diode D6, and the second terminal of the sixth inductor L6 is connected to the first terminal of the first switching circuit 40. The second terminal of the sixth diode D6 is connected to the second terminals of the plurality of fourth light sources 34 and the first electrode of the fifth transistor M5. The gate G of the fifth transistor M5 is connected to the second output terminal 420 of the third driving circuit 202, and the second electrode of the fifth transistor M5 is connected to a third grounding terminal GND3.

It should be noted that the principles of the fifth diode D5 and the sixth diode D6 are similar to the principle of the first diode D1, which may be made reference to the above descriptions and are not repeated any further.

Since the structures of the second circuit 901 and the third circuit 902 are the same, the working principles of the second circuit 901 and the third circuit 902 are described below by taking the second circuit 901 as an example.

In the case where the second circuit 901 includes the fifth inductor L5, the fifth diode D5 and the fourth transistor M4, the second driving circuit 201 is further configured to output a second signal DRV2 to the gate G of the fourth transistor M4 when outputting the second current I2 to the first light source 31.

For example, when the second signal DRV2 output by the second driving circuit 201 to the gate G of the fourth transistor M4 is at a low level, the source S and drain D of the fourth transistor M4 are turned on. At this time, the fifth diode D5 is in an off state. Thus, the connection between the second driving circuit 201 and the second grounding terminal GND2 is turned on such that the first light source 31 emits light. In this way, when the fifth diode D5 is in an on state, the first inductor L1 is in a charging state.

When the second signal DRV2 output by the second driving circuit 201 to the gate G of the fourth transistor M4 is at a high level, the source S and drain D of the fourth transistor M4 are turned off. At this time, the first diode D1 is in an on state, and the first inductor L1 is in a discharging state. Therefore, when the fifth diode D5 is in the off state, the electrical energy discharged by the first inductor L1 continues to drive the first light source 31 to emit light. In this way, the light emission stability of the first light source 31 can be increased.

Therefore, the second driving circuit 201 can change the turn-on duration of the fifth diode D5 by adjusting the duty ratio of the second signal DRV2. When the duty ratio of the second signal DRV2 is relatively larger per unit time (e.g., 1 second), the turn-off duration of the fifth diode D5 per unit time is longer, and the driving current flowing through the light source 30 is also smaller. When the duty ratio of the second signal DRV2 is relatively smaller per unit time, the turn-on duration of the fifth transistor M5 per unit time is longer, and the current flowing through the first light source 31 is also larger. In this way, by adjusting the duty ratio of the second signal DRV2, the current flowing through the first light source 31 can be regulated, which helps to obtain the rated current required by the first light source 31.

In some embodiments, as shown in FIG. 18, the projection device 100 further includes a second sampling resistor R2 and a third sampling resistor R3. The first terminal of the second sampling resistor R2 is connected to the second circuit 901 and the third input terminal 83 of the second driving circuit 201, and the second terminal of the second sampling resistor R2 is connected to the second grounding terminal GND2. The second sampling resistor R2 is configured to sample the second current I2. The first terminal of the third sampling resistor R3 is connected to one terminal of the third circuit 902 that is the third grounding terminal GND3, and the fourth input terminal 44 of the third driving circuit 202, and the second terminal of the third sampling resistor R3 is connected to the third grounding terminal GND3. The third sampling resistor R3 is configured to sample the third current I3.

For instance, when the third current I3 sampled by the third sampling resistor R3 is less than the rated current, the third driving circuit 202 can reduce the duty ratio of the second signal DRV2. In this way, the turn-on duration of the first transistor M1 can be increased, thereby increasing the third current I3. When the third current I3 sampled by the third sampling resistor R is greater than the rated current, the third driving circuit 202 can increase the duty ratio of the second signal DRV2. In this way, the turn-on duration of the first transistor M1 can be reduced, thereby decreasing the third current I3.

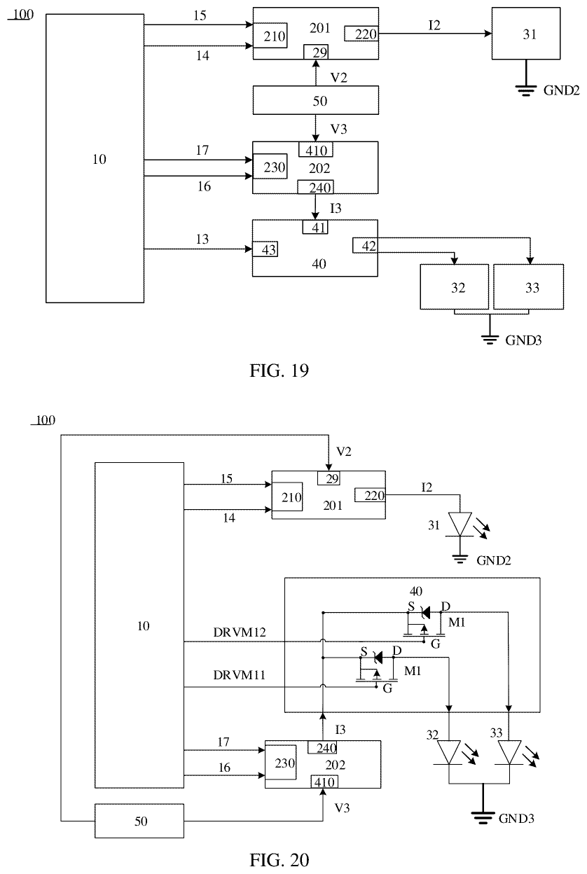

FIG. 19 is another circuit diagram of a projection device according to some embodiments, and FIG. 20 is another circuit diagram of a projection device according to some embodiments. In some embodiments, as shown in FIG. 19 and FIG. 20, the projection device 100 further includes a power circuit 50. The power circuit 50 is connected to the second input terminal 29 of the second driving circuit 201 and the third input terminal 410 of the third driving circuit 202. The power circuit 50 is configured to supply a second voltage V2 to the second driving circuit 201 and input a third voltage V3 to the third driving circuit 202. Here, the voltage value of the second voltage V2 is the same as that of the third voltage V3. The power circuit 50 includes an AC-DC converter. The second power circuit may also be replaced with a battery or another energy-supplying device, which is not limited in the present disclosure.

In the projection device 100 provided in some embodiments of the present disclosure, the projection device 100 only needs two driving circuits and one first switching circuit 40 to sequential light emission of the plurality of light sources 30 of different colors. Moreover, only the second circuit 901 and the third circuit 902 need to be provided in order to adjust the current. The structure of the circuit board controlling the light source 30 in the projection device 100 is simplified and the cost is reduced. In addition, since the structure of the circuit board controlling the light source 30 in the projection device 100 is relatively simpler and has a smaller area, it is convenient to integrate this circuit board with the light source 30, which facilitates the integration of the circuit board and the light sources 30 and is beneficial for the miniaturization of the projection device 100.

Additionally, in the projection device 100 provided in some embodiments of the present disclosure, only one fourth transistor M4 and one fifth transistor M5 are in a high-speed on and off state, which can effectively reduce the heat and electromagnetic radiation generated during the process of regulating the current. Therefore, the heat dissipation device (such as heat sink) and the devices used to shield electromagnetic radiation (such as magnetic rings) can be omitted in the projection device 100, thereby simplifying the structure and reducing the cost of the projection device 100.

The above descriptions of the projection device 100 are provided by taking an example where the switching circuit (i.e., the first switching circuit 40) controls the turn-on and turn-off of the wire between the plurality of fourth light sources 34 and the third driving circuit 202. In some embodiments, in the projection device 100, the light emission of the plurality of light sources 30 at different times may also be achieved by controlling the turn-on and turn-off of the wire between the plurality of fourth light sources 34 and the third grounding terminal GND3.

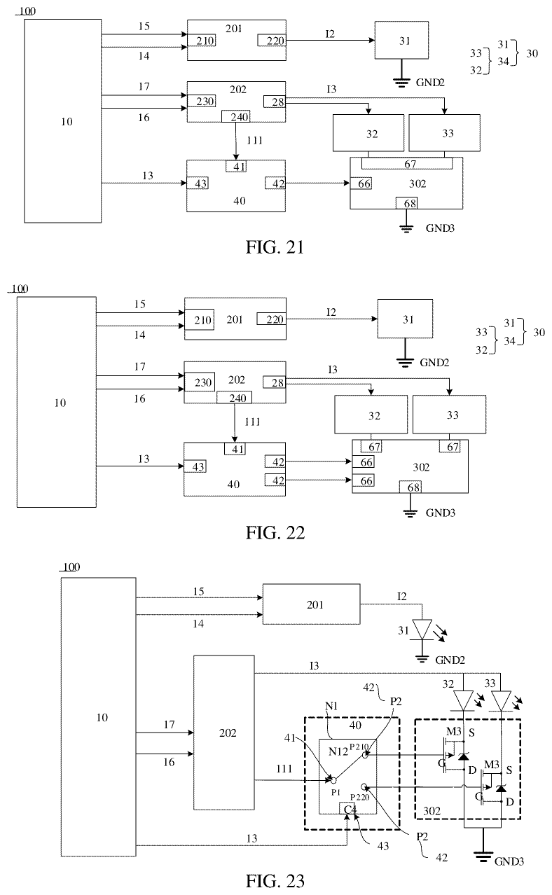

FIG. 21 is a circuit diagram of another projection device according to some embodiments. For example, as shown in FIG. 21, the projection device 100 includes a control circuit 10, a first switching circuit 40, a second switching circuit 302, a second driving circuit 201, a third driving circuit 202, and a plurality of light sources 30. The plurality of light sources 30 are configured to emit light beams of different colors, and the plurality of light sources include a first light source 31 and a plurality of fourth light sources 34. The plurality of fourth light sources 34 include a second light source 32 and a third light source 33. For the structure of control circuit 10, reference may be made to the above descriptions and is not repeated any further.

The control circuit 10 is configured to: based on the light emission information of the plurality of light sources 30, transmit the second enable signal 14 and the second driving signal 15 to the second driving circuit 201, transmit at least one third enable signal 16 and a plurality of third driving signals 17 to the third driving circuit 202, and transmit the first switching signal 13 to the first switching circuit 40.

The first input terminal 210 of the second driving circuit 201 is connected to the control circuit 10, the first output terminal 220 of the second driving circuit 201 is connected to the first terminal of the first light source 31, and the second terminal of the first light source 31 is connected to the second grounding terminal GND2.

The first input terminal 230 of the third driving circuit 202 is connected to the control circuit 10, the second output terminal 28 of the third driving circuit 202 is connected to the first terminals of the plurality of fourth light sources 34, and the first output terminal 240 of the third driving circuit 202 is connected to the first terminal 41 of the first switching circuit 40. The third driving circuit 202 is configured to output the third current I3 and output the third switching signal 111 to the first switching circuit 40 based on the third enable signal 16 and the at least one third driving signal 17.

The control terminal 43 of the first switching circuit 40 is connected to the control circuit 10, and the second terminal 42 of the first switching circuit 40 is connected to the control terminal 66 of the second switching circuit. The first switching circuit 40 is configured to transmit a third switching signal 111 to the second switching circuit 302 based on the first switching signal 13.

The first terminal 67 of the second switching circuit 302 is connected to the second terminals of the plurality of fourth light sources 34, and the second terminal 68 of the second switching circuit 302 is connected to the third grounding terminal GND3. The second switching circuit 302 is configured to in sequence turn on the connection between the plurality of fourth light sources 34 and the third grounding terminal GND3 based on the third switching signal 111, to drive the plurality of fourth light sources 34 to emit light in sequence.

FIG. 22 is another circuit diagram of a projection device according to some embodiments. In some embodiments, as shown in FIG. 22, the second switching circuit 302 includes a plurality of first terminals 67 and a plurality of control terminals 66. The plurality of control terminals 66 correspond to the plurality of first terminals 67, respectively. The plurality of first terminals 67 of the second switching circuit 302 are connected to the second terminals of the plurality of fourth light sources 34 respectively, and the plurality of control terminals 66 of the second switching circuit 302 are connected to the plurality of second terminals 42 of the first switching circuit 40 respectively.

In the case where the second switching circuit 302 includes a plurality of first terminals 67 and a plurality of control terminals 66, the control circuit 10 is further configured to output, based on the light emission information of the plurality of light sources 30, a first switching signal 13 to the first switching circuit 40 to control the turn-on or turn-off of the first switching circuit 40. The turn-on and turn-off of the first switching circuit 40 refer to the turn-on and turn-off of the connection between the first terminal 41 of the first switching circuit 40 and one of the plurality of second terminals 42 of the first switching circuit 40.

When the third driving circuit 202 receives the third enable signal 16 and the third driving signal 17, the third driving circuit 202 outputs the third switching signal 111 to the first terminal 41 of the first switching circuit 40, and the first switching circuit 40 turns on, based on the first switching signal 13, the connection between the first terminal 41 of the first switching circuit 40 to one of the plurality of second terminals 42 of the first switching circuit 40. In this way, the first switching circuit 40 can transmit the received third switching signal 111 from the first terminal 41 to the turn-on second terminal 42, and then transmit the third switching signal 111 to the control terminal 66 of the second switching circuit 302 which is connected to the second terminal 42.

When the control terminal 66 of the second switching circuit 302 receives the third switching signal 111, the second switching circuit 302 turns on the connection between the first terminal 67 corresponding to the control terminal 66 and the second terminal 68, so as to turn on the connection between the target fourth light source 34 in plurality of fourth light sources 34 and the third grounding terminal GND3. In this way, the third current I3 output by the third driving circuit 202 can flow through the turned-on fourth light source 34 to the second grounding terminal GND2 to drive the turned-on fourth light source 34 to emit light.

In some embodiments of the present disclosure, the second current I2 output by the second driving circuit 201 directly drives the first light source 31 to emit light. The third current I3 output by the third driving circuit 202 needs to be transmitted, under the control of the first switching circuit 40 and the second switching circuit 302, to one fourth light source of the plurality of fourth light sources 34, wherein the connection between the one fourth light source and the third grounding terminal GND3 is turned on.

In some embodiments, the control circuit 10 controls, through the second driving circuit 201 and the third driving circuit 202, the first light source 31 and the plurality of fourth light sources 34 to emit light in sequence. At this time, the light-emitting period of the first light source 31 is staggered from the light-emitting periods of the plurality of second light sources 32. For example, the control circuit 10 first outputs the second enable signal 14 and the second driving signal 15 to the second driving circuit 201, such that the second driving circuit 201 drives the first light source 31 to emit light. After the light-emitting duration of the first light source 31 reaches a first light-emitting duration Duty1 of the first light source 31, the control circuit 10 outputs the third enable signal 16 and the third driving signal 17 to the third driving circuit 202, and outputs the first switching signal 13 to the first switching circuit 40, such that the third driving circuit 202 drives the plurality of fourth light sources 34 to emit light in sequence. Here, for the first light-emitting duration of Duty1, reference may be made to the descriptions above, which are not repeated any further.

In some embodiments, when the control circuit 10 outputs the second enable signal 14 and the second driving signal 15 to the second driving circuit 201, the control circuit 10 is further configured to output the third enable signal 16 and the third driving signal 17 to the third driving circuit 202 and transmit the first switching signal 13 to the first switching circuit 40. At this time, the first light source 31 emits light simultaneously with one of the fourth light sources 34 in the plurality of second light sources 32.

In some embodiments of the present disclosure, the first switching circuit 40 controls, based on the first switching signal 13, the connection between the first terminal 41 of the first switching circuit 40 and one of the plurality of second terminals 42 to be turned on. In this way, the third switching signal 111 transmitted by the third driving circuit 202 is transmitted to the second switching circuit 302 through the first switching circuit 40. Furthermore, the second switching circuit 302 turns on, based on the third switching signal 111, the connection between one of the plurality of first terminals 67 and the second terminal 68, such that the connection between one of the plurality of fourth light sources 34 and the third grounding terminal GND3 is turned on. In this way, one third driving circuit 202 can drive the plurality of fourth light sources 34 to emit light respectively. Therefore, the structure of the projection device 100 is simplified. Moreover, the projection device 100 only needs the second driving circuit 201, the third driving circuit 202, one first switching circuit 40 and one second switching circuit 302 in order to achieve the light emission of the plurality of light sources 30 of different colors, which reduces the manufacturing cost of the projection device 100.

FIG. 23 is another circuit diagram of a projection device according to some embodiments. In some embodiments, as shown in FIG. 23, the first switching circuit 40 includes a single-pole multi-throw switch N1. As shown in FIG. 23, the control terminal C4 of the single-pole multi-throw switch N1 serves as the control terminal 43 of the first switching circuit 40, the first terminal P1 of the single-pole multi-throw switch N1 is the first terminal 41 of the first switching circuit 40, and the second terminal P2 of the single-pole multi-throw switch N1 is the second terminal 42 of the first switching circuit 40.

In some embodiments, the third switching signal 111 includes a third sub-signal of a first level and a fourth sub-signal of a second level. The single-pole multi-throw switch N1 is a single-pole double-throw switch N12, and the single-pole double-throw switch N12 is configured to: transmit, in response to receiving the third sub-signal, the third switching signal 111 to the control terminal 66, corresponding to the second light source 32, of the second switching circuit 302, and transmit, in response to receiving the fourth sub-signal, the third switching signal 111 to the control terminal 66, corresponding to the third light source 33, of the second switching circuit 302.

In some embodiments, when the control terminal 66, corresponding to one fourth light source 34, of the second switching circuit 302 receives the third switching signal 111, the second switching circuit 302 turns on the connection between the fourth light source 34 and the third grounding terminal GND3, such that the fourth light source 34 emits light under the drive of the third current I3. At this time, the other one of the two fourth light sources 34 does not emit light. When the control terminal 66, corresponding to the other fourth light source 34, of the second switching circuit 302 receives the third switching signal 111, the second switching circuit 302 turns on the connection between the other fourth light source 34 and the third grounding terminal GND3, such that the other fourth light source 34 emits light under the drive of the third current I3.

In some embodiments, as shown in FIG. 23, the second switching circuit 302 includes a plurality of third transistors M3, and the plurality of third transistors M3 correspond to the plurality of fourth light sources 34 respectively. The gates (G) of the plurality of third transistors M3 serve as the control terminals 66 of the second switching circuit 302, the first terminals 67 of the plurality of third transistors M3 serve as the first terminals 67 of the second switching circuit 302, and the second terminals 68 of the plurality of third transistors M3 serve as the second terminal of the second switching circuit 302.

For the principle of the third transistor M3, reference may be made to the descriptions above, which are not repeated any further. In the case where the second switching circuit 302 includes a plurality of third transistors M3 and the plurality of third transistors M3 correspond to the plurality of fourth light sources 34 respectively, the control circuit 10 is further configured to output corresponding third switching signals 111 to the gates G of the plurality of third transistors M3 in the second switching circuit 302 respectively and output the third enable signal 16 to the third driving circuit 202.

When the single-pole multi-throw switch N1 receives the first switching signal 13 transmitted by the control circuit 10, the single-pole multi-throw switch N1 turns on and turns off, based on the first switching signal 13, the first terminal P1 and any one of the plurality of second terminals P2 of the single-pole multi-throw switch N1, thereby controlling the turn-on and turn-off of the connection between the first switching circuit 40 and any third transistor M3 in the second switching circuit 302. In this way, the third switching signal 111 received by the first terminal P1 of the single-pole multi-throw switch N1 is transmitted to the gate G of the turned-on third transistor M3.

For example, as shown in FIG. 23, when the single-pole double-throw switch N12 receives the third sub-signal, the single-pole multi-throw switch N1 turns on the first terminal P1 and a first second terminal P210, thereby transmitting the third switching signal 111 to the third transistor M3 connected to the first second terminal P210. When the single-pole double-throw switch N12 receives the fourth sub-signal, the single-pole multi-throw switch N1 turns on the first terminal P1 and a second second terminal P220, thereby transmitting the third switching signal 111 to the third transistor M3 connected to the second second terminal P220.

When one third transistor M3 in the second switching circuit 302 receives the third switching signal 111, the third transistor M3 turns on the source S and the drain D based on the third switching signal 111, thereby turning on the connection between the fourth light source 34 connected to the third transistor M3 and the third grounding terminal GND3. In this way, the third current I3 flows through the turned-on fourth light source 34 to the third grounding terminal GND3, thereby driving the turned-on fourth light source 34 to emit light. Furthermore, in the second switching circuit 302, the source S and drain D of the third transistor M3 that does not receive the third switching signal 111 are turned off.

It should be noted that the turn-on duration of the source S and drain D of the third transistor M3 corresponding to the target fourth light source is set light-emitting duration of the target fourth light source. When the control circuit 10 determines that the turn-on duration of the source S and drain D of the third transistor M3 corresponding to the target fourth light source reaches the set light-emitting duration of the target fourth light source, the control circuit 10 may turn off the third transistor M3 corresponding to the target fourth light source by controlling the turn-on and turn-off of the single-pole multi-throw switch N1, such that the target fourth light source stops emitting light. Furthermore, the control circuit 10 may also turn on the connection between the third driving circuit 202 and the third transistor M3 corresponding to another fourth light source by controlling the turn-on and turn-off of the single-pole multi-throw switch N1, such that the target fourth light source stops emitting light, thereby driving the another fourth light source 34 to emit light at the third current I3.

In some embodiments, the control circuit 10 is further configured to: in response to the third transistor M3 corresponding to the target fourth light source stopping receiving the third switching signal 111 for a second target duration, turn on the connection between the third driving circuit 202 and the third transistor M3 corresponding to another fourth light source 34 through the single-pole multi-throw switch N1. Here, the second target duration is determined based on needs.

It should be noted that the waveform diagram of the plurality of signals in some embodiments of the present disclosure is the same as that as shown in FIG. 17, and reference may be made to the descriptions above, which is not repeated any further.

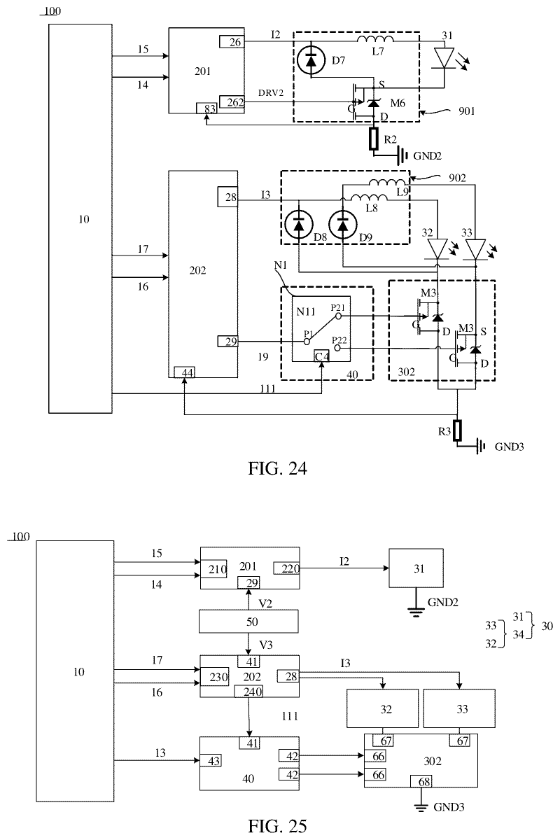

FIG. 24 is another circuit diagram of a projection device according to some embodiments.

In some embodiments, as shown in FIG. 24, the projection device 100 further includes a second circuit 901 and a third circuit 902. The second circuit 901 is connected to the third output terminal 26 and fourth output terminal 262 of the second driving circuit 201 and the first light source 31. The second circuit 901 is configured to regulate the second current I2. The second circuit 901 includes a seventh inductor L7, a seventh diode D7, and a sixth transistor M6. The first terminal of the seventh inductor L7 is connected to the third output terminal 26 of the second driving circuit 201 and the first terminal of the seventh diode D7, and the second terminal of the seventh inductor L7 is connected to the first terminal of the first light source 31. The second terminal of the seventh diode D7 is connected to the second terminal of the first light source 31 and the first electrode of the sixth transistor M6. The gate G of the sixth transistor M6 is connected to the fourth output terminal 262 of the second driving circuit 201, and the second electrode of the sixth transistor M6 is connected to the second grounding terminal GND2.

The third circuit 902 is connected to the second output terminal 28 of the third driving circuit 202, the plurality of light sources 30 and the second switching circuit 302. The third circuit 902 is configured to regulate the third current I3. The third circuit 902 includes an eighth inductor L8, an eighth diode D8, a ninth inductor L9 and a ninth diode D9. The first terminal of the eighth inductor L8 is connected to the second output terminal 28 of the third driving circuit 202 and the first terminal of the eighth diode D8, and the second terminal of the eighth inductor L8 is connected to the first terminal of the second light source 32. The second terminal of the eighth diode D8 is connected to the second terminal of the second light source 32 and one of the plurality of first terminals 67 of the second switching circuit 302. The first terminal of the ninth inductor L9 is connected to the second output terminal 28 of the third driving circuit 202 and the first terminal of the ninth diode D9, and the second terminal of the ninth inductor L9 is connected to the first terminal of the third light source 33. The second terminal of the ninth diode D9 is connected to the second terminal of the third light source 33 and another one of the plurality of first terminals 67 of the second switching circuit 302.

It should be noted that the principles of the seventh diode D7 and the eighth diode D8 are similar to that of the first diode D1, and reference may be made to the descriptions above, which is not repeated any further.

In the case where the second circuit 901 includes the seventh inductor L7, the seventh diode D7 and the sixth transistor M6, the second driving circuit 201 is further configured to output the second signal DRV2 to the gate G of the sixth transistor M6 when the second driving circuit 201 outputs the second current I2 to the first light source 31.

For example, when the second signal DRV2 output by the second driving circuit 201 to the gate G of the sixth transistor M6 is at a low level, the source S and drain D of the sixth transistor M6 are turned on. At this time, the seventh diode D7 is in an off state. Thus, the connection between the second driving circuit 201 and the second grounding terminal GND2 is turned on such that the first light source 31 emits light. In this way, when the seventh diode D7 is in an on state, the seventh inductor L7 is in a charging state.

When the second signal DRV2 output by the second driving circuit 201 to the gate G of the seventh diode D7 is at a high level, the source S and drain D of the seventh diode D7 are turned off. At this time, the first diode D1 is in an on state, and the seventh inductor L7 is in a discharging state. Therefore, when the seventh diode D7 is in an off state, the electrical energy discharged by the seventh inductor L7 can continue to drive the first light source 31 to emit light. In this way, the light emission stability of the first light source 31 can be increased.

Therefore, the second driving circuit 201 can change the turn-on duration of the seventh diode D7 by adjusting the duty ratio of the second signal DRV2. When the duty ratio of the second signal DRV2 is relatively larger per unit time (e.g., 1 second), the turn-off duration of the seventh diode D7 per unit time is longer, and the driving current flowing through the light source 30 is also smaller. When the duty ratio of the second signal DRV2 is relatively smaller per unit time, the turn-on duration of the fifth transistor M5 per unit time is longer, and the current flowing through the first light source 31 is also larger. Therefore, by adjusting the duty ratio of the second signal DRV2, the current flowing through the first light source 31 can be regulated, which helps to obtain the rated current required by the first light source 31.

The working principle of the third circuit 902 is the same as that of the second circuit 901, and reference may be made to the descriptions above, which is not repeated any further.

In some embodiments, as shown in FIG. 24, the projection device 100 further includes a second sampling resistor R2 and a third sampling resistor R3. The first terminal of the second sampling resistor R2 is connected to the second circuit 901 and the third input terminal 83 of the second driving circuit 201, and the second terminal of the second sampling resistor R2 is connected to the second grounding terminal GND2. The second sampling resistor R2 is configured to sample the second current I2. The first terminal of the third sampling resistor R3 is connected to the second terminal 68 of the second switching circuit 302 and the fourth input terminal 44 of the third driving circuit 202, and the second terminal of the third sampling resistor R3 is connected to the third grounding terminal GND3. The third sampling resistor R3 is configured to sample the third current I3.

For the working principles of the second sampling resistor R2 and the third sampling resistor R3, reference may be made to in the descriptions above, which are not repeated any further.

FIG. 25 is another circuit diagram of a projection device according to some embodiments. In some embodiments, as shown in FIG. 25, the projection device 100 further includes a power circuit 50. The power circuit 50 is connected to the second input terminal 29 of the second driving circuit 201 and the third input terminal 41 of the third driving circuit 202. For the working principle of power circuit 50, reference may be made to in the descriptions above, which is not repeated any further.

In some embodiments of the present disclosure, the plurality of fourth transistors M4 in the second switching circuit 302 can control the switching of light emission of the plurality of fourth light sources 34, thereby effectively improving the utilization rate of the plurality of fourth transistors M4. Furthermore, since the projection device 100 can achieve the switching of light emission of the plurality of fourth light sources 34 only through a single-pole multi-throw switch N1 and two fourth transistors M4, the structure of projection device 100 is effectively simplified and the cost of projection device 100 is reduced.

Some embodiments of the present disclosure further provide a method for driving a light source of a projection device. The projection device is similar in structure to the projection device 100 described above. For example, the projection device includes a control circuit 10, a first driving circuit 20, a first switching circuit 40, and a plurality of light sources 30.

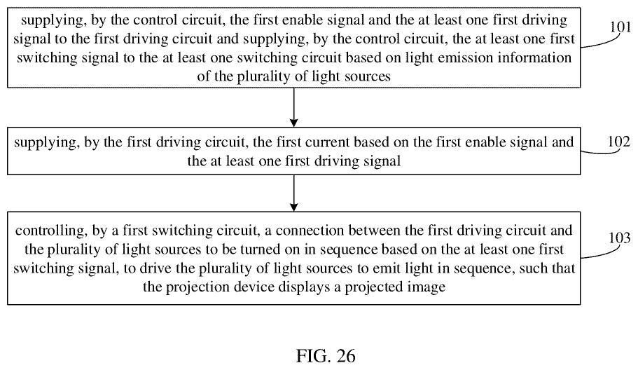

FIG. 26 is a flowchart of a method for driving a light source of a projection device according to some embodiments.

In some embodiments, as shown in FIG. 26, the method includes steps 101 to 103.

In step 101, the control circuit outputs a first enable signal and at least one first driving signal to the first driving circuit and outputs at least one first switching signal to at least one switching circuit based on light emission information of the plurality of light sources.

In step 102, the first driving circuit outputs a first current based on the first enable signal and the at least one first driving signal.

In step 103, the first switching circuit controls the connection between the first driving circuit and the plurality of light sources to be turned on in sequence based on the at least one first switching signal to drive the plurality of light sources to emit light in sequence, such that the projection device displays a projected image.

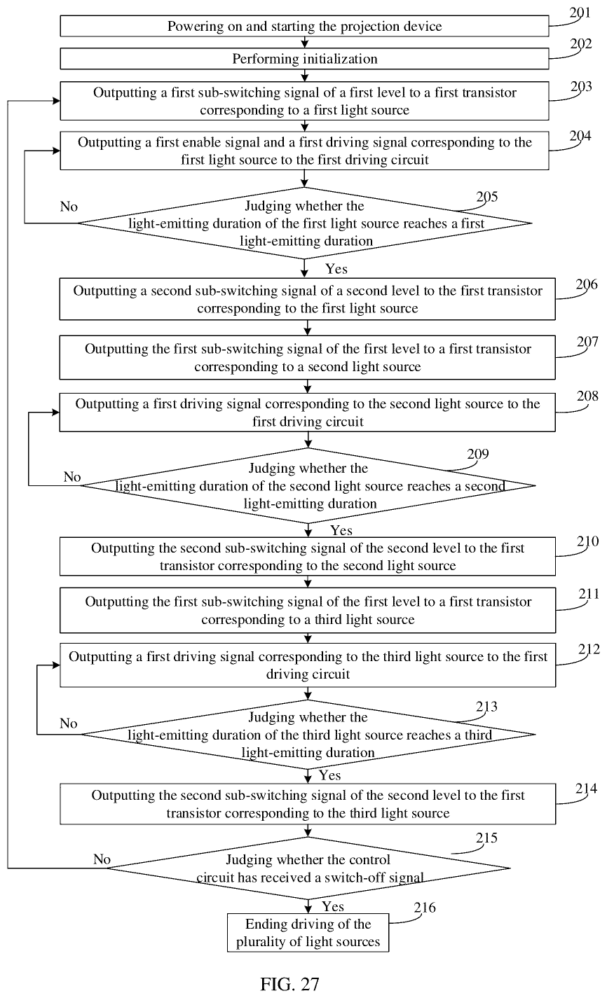

FIG. 27 is another flowchart of a method for driving a light source of a projection device according to some embodiments.

In some embodiments, as shown in FIG. 27, the method includes steps 201 to 216, and steps 202 to 216 are executed by a control circuit 10.

In step 201, the projection device 100 is powered on and started.

For example, the projection device 100 is powered on and started by remote control or by pressing a switch button of the projection device 100.

In step 202, initialization is performed.

For example, after the projection device 100 is powered on and started, the control circuit 10 performs initialization. During the initialization process, the control circuit 10 obtains the light emission information of the plurality of light sources 30 in the projection device 100.

In step 203, a first sub-switching signal of a first level is output to a first transistor M1 corresponding to a first light source 31.

In step 204, a first enable signal 11 of a third level and a first driving signal 12 corresponding to the first light source 31 are output to the first driving circuit 20.

In step 205, it is judged whether the light-emitting duration of the first light source 31 reaches a first light-emitting duration Duty1. If “Yes”, step 206 is executed; and if “No”, it returns to execute step 201.

In step 206, a second sub-switching signal of a second level is output to the first transistor M1 corresponding to the first light source 31.

In step 207, the first sub-switching signal of the first level is output to a first transistor M1 corresponding to a second light source 32.

In step 208, a first driving signal 12 corresponding to the second light source 32 is output to the first driving circuit 20.

In step 209, it is judged whether the light-emitting duration of the second light source 32 reaches a second a light-emitting duration Duty2. If “Yes”, step 210 is executed; and if “No”, it returns to execute step 208.

In step 210, the second sub-switching signal of the second level is output to the first transistor M1 corresponding to the second light source 32.

In step 211, the first sub-switching signal of the first level is output to a first transistor M1 corresponding to a third light source 33.

In step 212, a first driving signal 12 corresponding to the third light source 33 is output to the first driving circuit 20.

In step 213, it is judged whether the light-emitting duration of the third light source 33 reaches a third a light-emitting duration Duty3. If “Yes”, step 214 is executed; and if “No”, it returns to execute step 212.

In step 214, the second sub-switching signal of the second level is output to the first transistor M1 corresponding to the third light source 33.

In step 215, it is judged whether the control circuit 10 has received a switch-off signal. If “Yes”, step 216 is executed; and if “No”, it returns to execute step 203.

In step 216, driving of the plurality of light sources 30 is ended.

The present disclosure further provides a method for driving a light source of a projection device. For example, the projection device includes a control circuit 10, a plurality of driving circuits, a plurality of light sources 30 and a plurality of switching circuits. The plurality of driving circuits include a second driving circuit 201 and a third driving circuit 202. The plurality of switching circuits include a first switching circuit 40 and a second switching circuit 302. The plurality of light sources 30 include a first light source 31 and a plurality of fourth light sources 34, and a plurality of second light sources 32 include a second light source 32 and a third light source 33.

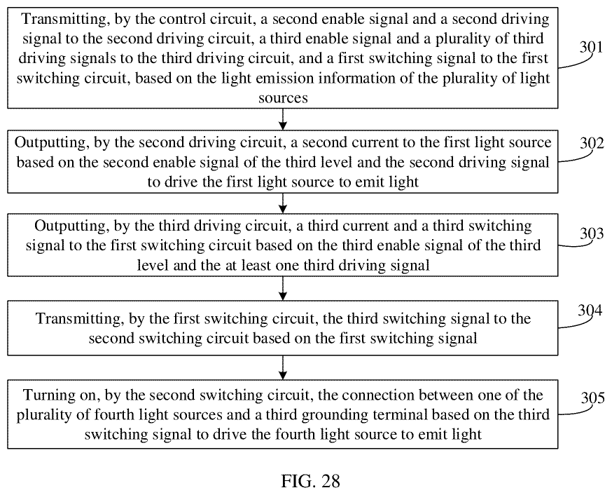

FIG. 28 is a flowchart of another method for driving a light source of a projection device according to some embodiments. In some embodiments, as shown in FIG. 28, the method includes steps 301 to 305.

In step 301, the control circuit 10 transmits a second enable signal 14 and a second driving signal 15 to the second driving circuit 201, transmits a third enable signal 16 and at least one third driving signal 17 to the third driving circuit 202, and transmits a first switching signal 13 to the first switching circuit 40, based on the light emission information of the plurality of light sources 30.

In step 302, the second driving circuit 201 outputs a second current I2 to the first light source 31 based on the second enable signal 14 of the third level and the second driving signal 15 to drive the first light source to emit light.

In step 303, the third driving circuit 202 outputs a third current I3 and outputs a third switching signal 111 to the first switching circuit 40 based on the third enable signal 16 of the third level and the at least one third driving signal 17.

In step 304, the first switching circuit 40 transmits the third switching signal 111 to the second switching circuit 302 based on the first switching signal 13.

In step 305, the second switching circuit 302 turns on the connection between one of the plurality of fourth light sources 34 and a third grounding terminal GND3 based on the third switching signal 111 to drive the fourth light source 34 to emit light.

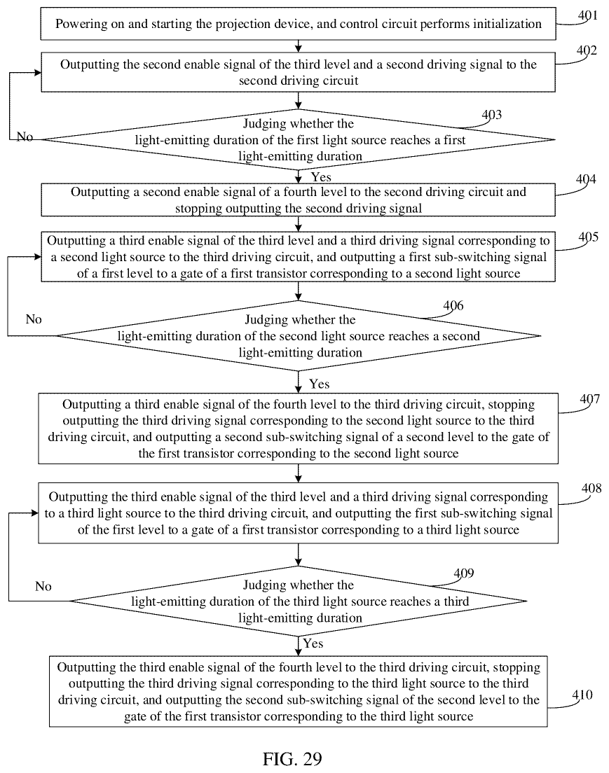

FIG. 29 is a flowchart of another method for driving a light source of a projection device according to some embodiments. In some embodiments, as shown in FIG. 29, the method includes steps 401 to 410.

In step 401, the projection device 100 is powered on and started, and the control circuit 10 performs initialization.

For example, the projection device 100 is powered on and started by remote control or by pressing a switch button of the projection device 100. After the projection device 100 is powered on and started, the control circuit 10 performs initialization. During the initialization process, the control circuit 10 obtains the light emission information of the plurality of light sources 30 in the projection device 100.

In step 402, the second enable signal 14 of the third level and a second driving signal 15 are output to the second driving circuit 201.

In step 403, it is judged whether the light-emitting duration of the first light source reaches a first light-emitting duration Duty1. If “Yes”, step 404 is executed; and if “No”, it returns to execute step 402.

In step 404, a second enable signal 14 of a fourth level is output to the second driving circuit 201 and the second driving signal 15 is stopped from being output.

In step 405, a third enable signal 16 of the third level and a third driving signal 17 corresponding to a second light source 32 are output to the third driving circuit 202, and a first sub-switching signal of a first level is output to a gate G of a first transistor M1 corresponding to a second light source 32.

In step 406, it is judged whether the light-emitting duration of the second light source 32 reaches a second light-emitting duration Duty2. If “Yes”, step 407 is executed; and if “No”, it returns to execute step 405.

In step 407, a third enable signal 16 of the fourth level is output to the third driving circuit 202, the third driving signal 17 corresponding to the second light source 32 is stopped from being output to the third driving circuit 202, and a second sub-switching signal of a second level is output to the gate G of the first transistor M1 corresponding to the second light source 32.

In step 408, the third enable signal 16 of the third level and a third driving signal 17 corresponding to a third light source 33 are output to the third driving circuit 202, and the first sub-switching signal of the first level is output to a gate G of a first transistor M1 corresponding to a third light source 33.

In step 409, it is judged whether the light-emitting duration of the third light source 33 reaches a third light-emitting duration Duty3. If “Yes”, step 410 is executed; and if “No”, it returns to execute step 408.

In step 410, the third enable signal 16 of the fourth level is output to the third driving circuit 202, and the third driving signal 17 corresponding to the third light source 33 is stopped from being output to the third driving circuit 202, and the second sub-switching signal of the second level is output to the gate G of the first transistor M1 corresponding to the third light source 33.

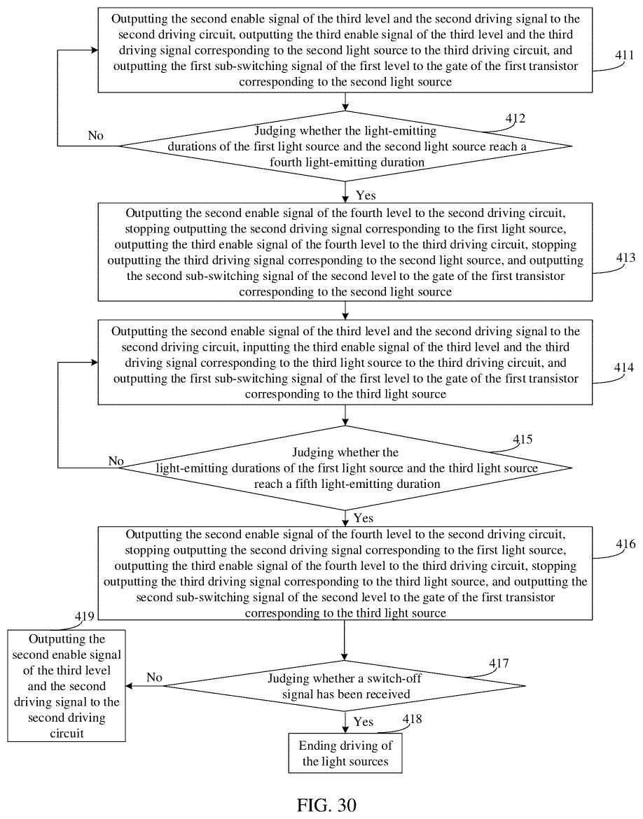

FIG. 30 is a flowchart of another method for driving a light source of a projection device according to some embodiments. In some embodiments, as shown in FIG. 30, the method includes steps 411 to 418.

In step 411, the second enable signal 14 of the third level and the second driving signal 15 are output to the second driving circuit 201, the third enable signal 16 of the third level and the third driving signal 17 corresponding to the second light source 32 are output to the third driving circuit 202, and the first sub-switching signal of the first level is output to the gate G of the first transistor M1 corresponding to the second light source 32.

In step 412, it is judged whether the light-emitting durations of the first light source 31 and the second light source 32 reach a fourth light-emitting duration Duty4. If “Yes”, step 413 is executed; and if “No”, it returns to execute step 411.

In step 413, the second enable signal 14 of the fourth level is output to the second driving circuit 201, the second driving signal 15 corresponding to the first light source 31 is stopped from being output, the third enable signal 16 of the fourth level is output to the third driving circuit 202, the third driving signal 17 corresponding to the second light source 32 is stopped from being output, and the second sub-switching signal of the second level is output to the gate G of the first transistor M1 corresponding to the second light source 32.

In step 414, the second enable signal 14 of the third level and the second driving signal 15 are output to the second driving circuit 201, the third enable signal 16 of the third level and the third driving signal 17 corresponding to the third light source 33 are input to the third driving circuit 202, and the first sub-switching signal of the first level is output to the gate G of the first transistor M1 corresponding to the third light source 33.

In step 415, it is judged whether the light-emitting durations of the first light source 31 and the third light source 33 reach a fifth light-emitting duration Duty5. If “Yes”, step 416 is executed; and if “No”, it returns to execute step 414.

In step 416, the second enable signal 14 of the fourth level is output to the second driving circuit 201, the second driving signal 15 corresponding to the first light source 31 is stopped from being output, the third enable signal 16 of the fourth level is output to the third driving circuit 202, and the third driving signal 17 corresponding to the third light source 33 is stopped from being output, and the second sub-switching signal of the second level is output to the gate G of the first transistor M1 corresponding to the third light source 33.

In step 417, it is judged whether a switch-off signal has been received. If “Yes”, step 418 is executed; and if “No”, step 419 is executed.

In step 418, driving of the light sources is ended.

In step 419, the second enable signal 14 of the third level and the second driving signal 15 are output to the second driving circuit 201.

Step 419 corresponds to step 402. If the control circuit 10 does not receive the switch-off signal, it returns to execute step 402.

The present disclosure further provides a method for driving a light source of a projection device. For example, the projection device includes a control circuit 10, a plurality of driving circuits, a plurality of light sources 30 and a plurality of switching circuits.

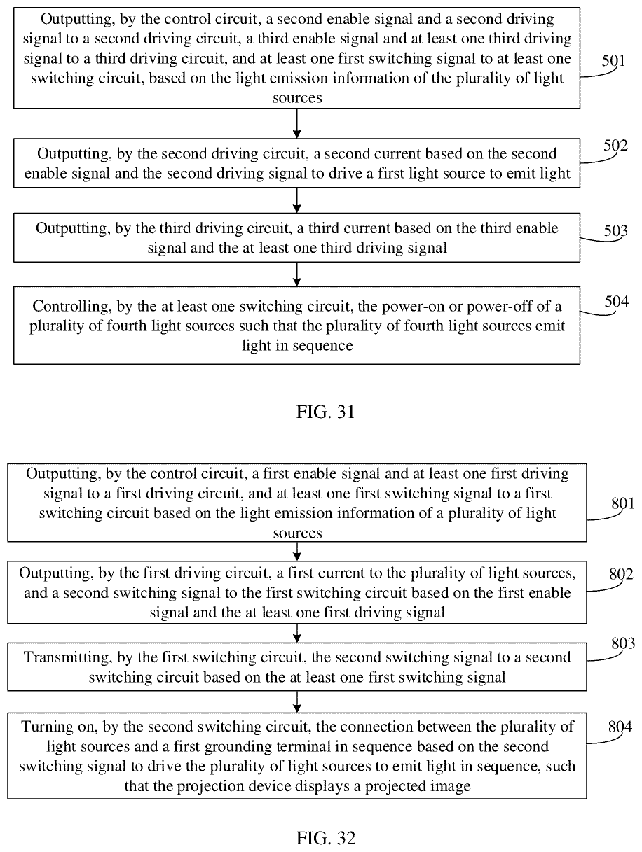

FIG. 31 is a flowchart of a method for driving a light source of another projection device according to some embodiments.

In some embodiments, as shown in FIG. 31, the method includes steps 501 to 504.

In step 501, the control circuit outputs a second enable signal and a second driving signal to a second driving circuit, outputs a third enable signal and at least one third driving signal to a third driving circuit, and outputs at least one first switching signal to at least one switching circuit, based on the light emission information of the plurality of light sources.

In step 502, the second driving circuit outputs a second current based on the second enable signal and the second driving signal to drive a first light source to emit light.

In step 503, the third driving circuit outputs a third current based on the third enable signal and the at least one third driving signal.

In step 504, the at least one switching circuit controls the power-on or power-off of a plurality of fourth light sources such that the plurality of fourth light sources emit light in sequence.

FIG. 32 is a flowchart of another method for driving a light source of a projection device according to some embodiments.

In some embodiments, as shown in FIG. 32, the method includes steps 801 to 804.

In step 801, the control circuit outputs a first enable signal and at least one first driving signal to a first driving circuit and outputs at least one first switching signal to a first switching circuit based on the light emission information of a plurality of light sources.

In step 802, the first driving circuit outputs a first current to the plurality of light sources and outputs a second switching signal to the first switching circuit based on the first enable signal and the at least one first driving signal.

In step 803, the first switching circuit transmits the second switching signal to a second switching circuit based on the at least one first switching signal.

In step 804, the second switching circuit in sequence turns on the connection between the plurality of light sources and a first grounding terminal based on the second switching signal to drive the plurality of light sources to emit light in sequence, such that the projection device displays a projected image.

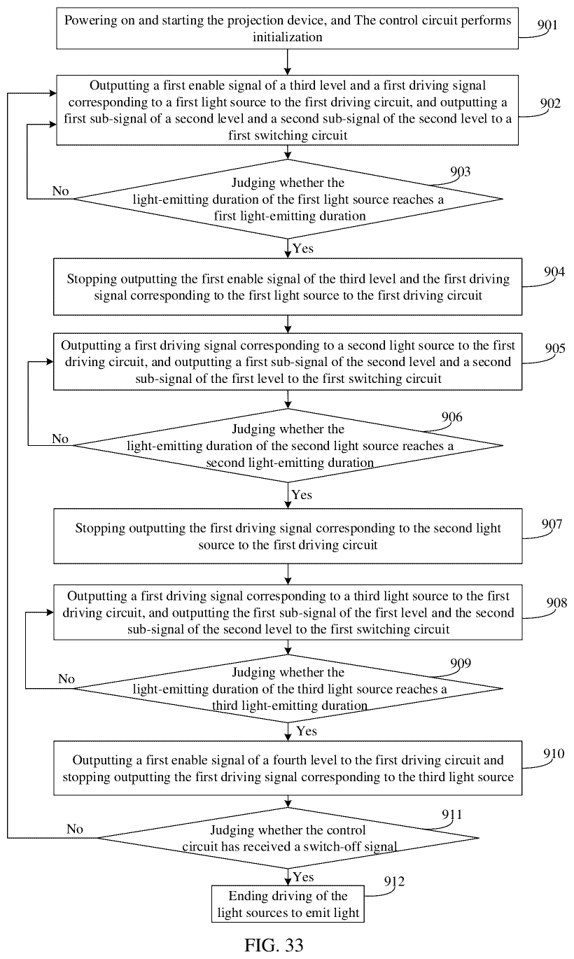

FIG. 33 is a flowchart of another method for driving a light source of a projection device according to some embodiments.

In some embodiments, as shown in FIG. 33, the method includes steps 901 to 912.

In step 901, the projection device 100 is powered on and started, and the control circuit 10 performs initialization.

For example, the projection device 100 is powered on and started by remote control or by pressing a switch button of the projection device 100. After the projection device 100 is powered on and started, the control circuit 10 performs initialization. During the initialization process, the control circuit 10 obtains the light emission information of the plurality of light sources 30 in the projection device 100.

In step 902, a first enable signal 11 of a third level and a first driving signal 12 corresponding to a first light source 31 are output to the first driving circuit 20, and a first sub-signal 181 of a second level and a second sub-signal 182 of the second level are output to a first switching circuit 40.

In step 903, it is judged whether the light-emitting duration of the first light source 31 reaches a first light-emitting duration Duty1. If “Yes”, step 909 is executed; and if “No”, it returns to execute step 902.

In step 904, the first enable signal 11 of the third level and the first driving signal 12 corresponding to the first light source 31 are stopped from being output to the first driving circuit 20.

In step 905, a first driving signal 12 corresponding to a second light source 32 is output to the first driving circuit 20, and a first sub-signal 181 of the second level and a second sub-signal 182 of the first level are output to the first switching circuit 40.

In step 906, it is judged whether the light-emitting duration of the second light source 32 reaches a second light-emitting duration Duty2. If “Yes”, step 901 is executed; and if “No”, it returns to execute step 905.

In step 907, the first driving signal 12 corresponding to the second light source 32 is stopped from being output to the first driving circuit 20.

In step 908, a first driving signal 12 corresponding to a third light source 33 is output to the first driving circuit 20, and the first sub-signal 181 of the first level and the second sub-signal 182 of the second level are output to the first switching circuit 40.

In step 909, it is judged whether the light-emitting duration of the third light source 33 reaches a third light-emitting duration Duty3. If “Yes”, step 910 is executed; and if “No”, it returns to execute step 908.

In step 910, the first driving circuit 20 outputs a first enable signal 11 of a fourth level and stops outputting the first driving signal 12 corresponding to the third light source 33 to the first driving circuit 20.

In step 911, it is judged whether the control circuit 10 has received a switch-off signal. If “Yes”, step 912 is executed; and if “No”, it returns to execute step 902.

In step 912, driving of the light sources 30 to emit light is ended.

If the control circuit 10 receives the switch-off signal, the driving process of the plurality of light sources 30 of the projection device 100 is ended. If the control circuit 10 does not receive the switch-off signal, when the connection between the third light source 33 and the first driving circuit 20 is turned off for the second target duration, it returns to execute step 902.

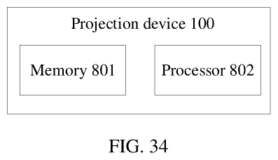

FIG. 34 is a circuit diagram of another laser projection device according to some embodiments.

As shown in FIG. 34, some embodiments of the present disclosure further provide a projection device 100. The projection device 100 further includes a memory 801 and a processor 802. The memory 801 stores one or more computer programs, and the one or more computer programs include instructions. When the instructions are executed by the processor 802, the processor 802 performs the methods for driving the light source of the projection device described above.

Some embodiments of the present disclosure provide a computer-readable storage medium (e.g., a non-transitory computer-readable storage medium), storing computer program instructions. The computer program instructions, when running on a computer, cause the computer to perform the method for driving the light source of the projection device described in any one of the above embodiments.

For example, the above computer-readable storage medium includes, but is not limited to: a magnetic storage device (e.g., hard disk, floppy disk or magnetic tape, etc.), an optical disc (e.g., compact disk (CS), a digital versatile disk (DVD), a smart card, a flash memory device (e.g., erasable programmable read-only memory (EPROM), a card, a stick, or a key driver. The various computer-readable storage media described in the present disclosure represent one or more devices and/or other machine-readable storage media used for storing information. The term “machine-readable storage media” include, but are not limited to, wireless channels and various other media capable of storing, containing and/or carrying instructions and/or data.

Some embodiments of the present disclosure further provide a computer program product, including computer program instructions. The computer program instructions, when running on a computer, cause the computer to perform the method for driving the light source of the projection device described in any one of the above embodiments.

Some embodiments of the present disclosure further provide a computer program. The computer program, when running on a computer, causes the computer to perform the method for driving the light source of the projection device described in any one of the above embodiments.

The beneficial effects of the above computer-readable storage medium, the computer program product and the computer program are the same as the beneficial effects of the method for driving the light source of the projection device in some of the embodiments described above, which are not repeated any further.

In the descriptions of the above embodiments, the specific features, structures, materials or characteristics may be combined in a suitable manner in in any one or more embodiments or examples.

Those skilled in the art will appreciate that the scope of the present disclosure is not limited to the above specific embodiments, and some elements in the embodiments may be amended or replaced without departing from the spirit and principles of the present disclosure. The scope of the present disclosure is defined by the appended claims.

1. A projection device, comprising:
a plurality of light sources, wherein different light sources emit different colors of light;
a first driving circuit connected to the plurality of light sources, wherein the first driving circuit is configured to supply a first current to the plurality of light sources based on a first enable signal and at least one first driving signal;
at least one switching circuit connected to the plurality of light sources, wherein the at least one switching circuit is configured to turn on or turn off the first current supplied to the plurality of light sources based on at least one first switching signal; and
a control circuit respectively connected to the first driving circuit and the at least one switching circuit, wherein the control circuit is configured to supply the first enable signal and the at least one first driving signal to the first driving circuit and supply the at least one first switching signal to the at least one switching circuit based on light emission information of the plurality of light sources, to enable the plurality of light sources to emit light in different light-emitting periods respectively based on the light emission information, wherein the light emission information comprises a light-emitting timing sequence, a light-emitting duration and a rated current.

2. The projection device according to claim 1, wherein the at least one switching circuit comprises a first switching circuit; wherein
a control terminal of the first switching circuit is connected to the control circuit, a first terminal of the first switching circuit is connected to a first output terminal of the first driving circuit, and a second terminal of the first switching circuit is connected to first terminals of the plurality of light sources; and the first switching circuit is configured to control, based on the at least one first switching signal, the first driving circuit to supply the first current to the plurality of light sources in sequence to drive the plurality of light sources to emit light in sequence;
a first input terminal of the first driving circuit is connected to the control circuit; and
second terminals of the plurality of light sources are connected to a first grounding terminal.

3. The projection device according to claim 2, wherein the first switching circuit comprises a plurality of first transistors, wherein the plurality of first transistors are in one-to-one correspondence with the plurality of light sources; gates of the plurality of first transistors are connected to a control terminal of the first switching circuit, first electrodes of the plurality of first transistors are connected to the first terminal of the first switching circuit, and second electrodes of the plurality of first transistors are connected to the second terminal of the first switching circuit;
the plurality of light sources are in one-to-one correspondence with a plurality of first switching signals, and the control circuit is further configured to supply the plurality of first switching signals to the plurality of first transistors to control the first driving circuit to supply the first current to the plurality of light sources in sequence.

4. The projection device according to claim 3, wherein the plurality of light sources are in one-to-one correspondence with a plurality of first driving signals;
the control circuit is further configured to: in a first period, supply a first level to a gate of a first transistor corresponding to a target light source based on the light emission information of the plurality of light sources, supply a second level to gates of first transistors other than the first transistor corresponding to the target light source in the plurality of first transistors, and supply a first driving signal corresponding to the target light source to the first driving circuit, based on the light emission information of the plurality of light sources, to enable the target light source to emit light in the first period based on the light emission information.

5. The projection device according to claim 2, further comprising a first circuit, wherein the first circuit comprises:
a first inductor, wherein a first terminal of the first inductor is connected to the first output terminal of the first driving circuit, and a second terminal of the first inductor is connected to the first terminal of the first switching circuit;
a first diode, wherein a first terminal of the first diode is connected to the first terminal of the first inductor, and a second terminal of the first diode is connected to the second terminals of the plurality of light sources; and
a second transistor, wherein a gate of the second transistor is connected to a second terminal of the first driving circuit, a first electrode of the second transistor is connected to the second terminal of the first diode, and a second electrode of the second transistor is connected to the first grounding terminal.

6. The projection device according to claim 1, wherein the at least one switching circuit comprises a first switching circuit and a second switching circuit; wherein
a control terminal of the first switching circuit is connected to the control circuit, a first terminal of the first switching circuit is connected to a second output terminal of the first driving circuit, and a plurality of second terminals of the first switching circuit are correspondingly connected to a plurality of control terminals of the second switching circuit; and the first switching circuit is configured to transmit a second switching signal to the second switching circuit based on the first switching signal;
the plurality of control terminals of the second switching circuit are in one-to-one correspondence with the plurality of light sources, a plurality of first terminals of the second switching circuit are correspondingly connected to second terminals of the plurality of light sources, and a second terminal of the second switching circuit is connected to a first grounding terminal; and the second switching circuit is configured to turn on a connection between the plurality of light sources and the first grounding terminal in sequence based on the second switching signal to drive the plurality of light sources to emit light in sequence;
a first input terminal of the first driving circuit is connected to the control circuit, and a first output terminal of the first driving circuit is connected to first terminals of the plurality of light sources; and the first driving circuit is further configured to supply the second switching signal to the first switching circuit based on the first enable signal and the at least one first driving signal.

7. The projection device according to claim 6, wherein the first switching circuit comprises
a single-pole multi-throw switch, wherein the single-pole multi-throw switch comprises:
a control terminal connected to the control terminal of the first switching circuit;
a first terminal connected to the first terminal of the first switching circuit; and
a plurality of second terminals connected in one-to-one correspondence with the plurality of second terminals of the first switching circuit;
wherein the second switching circuit is further configured to control, in response to that any control terminal in the plurality of control terminals of the second switching circuit receives the second switching signal, a connection between a light source corresponding to the control terminal and the first grounding terminal to be turned on to enable the light source to emit light.

8. The projection device according to claim 7, wherein the plurality of light sources comprise a first light source, a second light source, and a third light source; the first switching signal comprises a first sub-signal and a second sub-signal; the single-pole multi-throw switch is a single-pole triple-throw switch, the single-pole triple-throw switch being configured to: transmit, in response to receiving the first sub-signal of a second level and the second sub-signal of the second level, the second switching signal to a control terminal corresponding to the first light source in the second switching circuit, transmit, in response to receiving the first sub-signal of the second level and the second sub-signal of a first level, the second switching signal to a control terminal corresponding to the second light source in the second switching circuit, and transmit, in response to receiving the first sub-signal of the first level and the second sub-signal of the second level, the second switching signal to a control terminal corresponding to the third light source in the second switching circuit.

9. The projection device according to claim 6, wherein the second switching circuit comprises a plurality of third transistors, the plurality of third transistors being in one-to-one correspondence with the plurality of light sources; gates of the plurality of third transistors are connected to the plurality of control terminals of the second switching circuit, first electrodes of the plurality of third transistors are correspondingly connected to the plurality of first terminals of the second switching circuit, and second electrodes of the plurality of third transistors are connected to the second terminal of the second switching circuit;
the plurality of light sources are in one-to-one correspondence with a plurality of first driving signals, and the control circuit is further configured to control, in a period when supplying the first driving signal corresponding to one light source in the plurality of light sources, the third transistor corresponding to the one light source to be turned on.

10. The projection device according to claim 6, further comprising a first circuit, wherein the plurality of light sources comprise a first light source, a second light source, and a third light source, the first circuit comprising:
a second inductor, wherein a first terminal of the second inductor is connected to the first output terminal of the first driving circuit, and a second terminal of the second inductor is connected to a first terminal of the first light source;
a second diode, wherein a first terminal of the second diode is connected to the first terminal of the second inductor, and a second terminal of the second diode is connected to a second terminal of the first light source and one first terminal in the plurality of first terminals of the second switching circuit;
a third inductor, wherein a first terminal of the third inductor is connected to the first output terminal of the first driving circuit, and a second terminal of the third inductor is connected to a first terminal of the second light source;
a third diode, wherein a first terminal of the third diode is connected to the first terminal of the third inductor, and a second terminal of the third diode is connected to a second terminal of the second light source and another first terminal in the plurality of first terminals of the second switching circuit;
a fourth inductor, wherein a first terminal of the fourth inductor is connected to the first output terminal of the first driving circuit, and a second terminal of the fourth inductor is connected to a first terminal of the third light source; and
a fourth diode, wherein a first terminal of the fourth diode is connected to the first terminal of the fourth inductor, and a second terminal of the fourth diode is connected to a second terminal of the third light source and still another first terminal in the plurality of first terminals of the second switching circuit.

11. The projection device according to claim 1, further comprising a light source circuit, wherein the light source circuit is connected to the first driving circuit and is configured to supply a light source voltage to the first driving circuit.

12. A method for driving a light source of a projection device, wherein the projection device is the projection device according to claim 1;
the method comprising:
supplying, by the control circuit, the first enable signal and the at least one first driving signal to the first driving circuit and supplying, by the control circuit, the at least one first switching signal to the at least one switching circuit based on light emission information of the plurality of light sources, wherein the light emission information comprises a light-emitting timing sequence, a light-emitting duration and a rated current;
supplying, by the first driving circuit, the first current based on the first enable signal and the at least one first driving signal; and
controlling, by a first switching circuit which is one of the at least one switching circuit, a connection between the first driving circuit and the plurality of light sources to be turned on in sequence based on the at least one first switching signal, to enable the first driving circuit to supply the first current to the plurality of light sources in sequence to drive the plurality of light sources to emit light in sequence based on the light emission information.

13. A projection device, comprising:
a plurality of light sources comprising a first light source and a plurality of fourth light sources, wherein different light sources emit different colors of light;
a second driving circuit connected to the first light source, wherein the second driving circuit is configured to supply a second current to the first light source based on a second enable signal and a second driving signal;
a third driving circuit connected to the plurality of fourth light sources, wherein the third driving circuit is configured to supply a third current to the plurality of fourth light sources based on a third enable signal and at least one third driving signal;
at least one switching circuit connected to the plurality of fourth light sources, wherein the at least one switching circuit is configured to turn on or turn off the third current supplied to the plurality of fourth light sources based on at least one first switching signal; and
a control circuit connected to the second driving circuit, the third driving circuit and the at least one switching circuit, wherein the control circuit is configured to supply the second enable signal and the second driving signal to the second driving circuit, supply the third enable signal and the at least one third driving signal to the third driving circuit, and supply the at least one first switching signal to the at least one switching circuit based on light emission information of the plurality of light sources, to enable the plurality of light sources to emit light in different light-emitting periods respectively based on the light emission information, wherein the light emission information comprises a light-emitting timing sequence, a light-emitting duration and a rated current.

14. The projection device according to claim 13, further comprising a second circuit and a third circuit;
wherein the second circuit comprises:
a fifth inductor, wherein a first terminal of the fifth inductor is connected to a first output terminal of the second driving circuit, and a second terminal of the fifth inductor is connected to a first terminal of the first light source;
a fifth diode, wherein a first terminal of the fifth diode is connected to the first terminal of the fifth inductor, and a second terminal of the fifth diode is connected to a second terminal of the first light source and a first electrode of a fourth transistor; and
the fourth transistor, wherein a gate of the fourth transistor is connected to a second output terminal of the second driving circuit, and a second electrode of the fourth transistor is connected to a second grounding terminal;
wherein the third circuit comprises:
a sixth inductor, wherein a first terminal of the sixth inductor is connected to a first output terminal of the third driving circuit, and a second terminal of the sixth inductor is connected to a first terminal of the first switching circuit;
a sixth diode, wherein a first terminal of the sixth diode is connected to the first terminal of the sixth inductor, and a second terminal of the sixth diode is connected to second terminals of the plurality of fourth light sources and a first electrode of a fifth transistor; and
the fifth transistor, wherein a gate of the fifth transistor is connected to a second output terminal of the third driving circuit, and a second electrode of the fifth transistor is connected to a third grounding terminal.

15. The projection device according to claim 13, wherein the at least one switching circuit comprises a first switching circuit and a second switching circuit; wherein
a first input terminal of the second driving circuit is connected to the control circuit, a first output terminal of the second driving circuit is connected to a first terminal of the first light source, and a second terminal of the first light source is connected to a second grounding terminal;
a first input terminal of the third driving circuit is connected to the control circuit, a first output terminal of the third driving circuit is connected to first terminals of the plurality of fourth light sources, and a second output terminal of the third driving circuit is connected to a first terminal of the first switching circuit; and the third driving circuit is further configured to output a third switching signal to the first switching circuit based on the third enable signal and the at least one third driving signal;
a control terminal of the first switching circuit is connected to the control circuit, a plurality of second terminals of the first switching circuit are correspondingly connected to a plurality of control terminals of the second switching circuit; and the first switching circuit is configured to transmit a third switching signal to the second switching circuit based on the first switching signal;
the plurality of control terminals of the second switching circuit are in one-to-one correspondence with the plurality of fourth light sources, a plurality of first terminals of the second switching circuit are correspondingly connected to second terminals of the plurality of fourth light sources, and a second terminal of the second switching circuit is connected to a third grounding terminal; and the second switching circuit is configured to turn on a connection between the plurality of fourth light sources and the third grounding terminal in sequence based on the third switching signal to drive the plurality of fourth light sources to emit light in sequence.

16. The projection device according to claim 15, wherein the first switching circuit comprises a single-pole multi-throw switch, wherein the single-pole multi-throw switch comprises:
a control terminal connected to the control terminal of the first switching circuit;
a first terminal connected to the first terminal of the first switching circuit; and
a plurality of second terminals connected to the plurality of second terminals of the first switching circuit;
wherein the second switching circuit is further configured to control, in response to that any control terminal in the plurality of control terminals of the second switching circuit receives the third switching signal, a connection between a fourth light source corresponding to the control terminal and the third grounding terminal to be turned on to enable the fourth light source to emit light.

17. The projection device according to claim 16, wherein the plurality of fourth light sources comprise a second light source and a third light source;
the single-pole multi-throw switch is a single-pole double-throw switch, the single-pole double-throw switch being configured to: transmit, in response to receiving a first level, the third switching signal to a control terminal corresponding to the second light source in the second switching circuit, and transmit, in response to receiving a second level, the third switching signal to a control terminal corresponding to the third light source in the second switching circuit.

18. The projection device according to claim 15, wherein the second switching circuit comprises a plurality of third transistors, the plurality of third transistors being in one-to-one correspondence with the plurality of fourth light sources; gates of the plurality of third transistors are correspondingly connected to the plurality of control terminals of the second switching circuit, first electrodes of the plurality of third transistors are correspondingly connected to the plurality of first terminals of the second switching circuit, and second electrodes of the plurality of third transistors are correspondingly connected to the second terminal of the second switching circuit;
the plurality of fourth light sources are in one-to-one correspondence with a plurality of third driving signals, and the control circuit is further configured to control, in a period when supplying the third driving signal corresponding to one fourth light source in the plurality of fourth light sources, the third transistor corresponding to the one fourth light source to be turned on.

19. The projection device according to claim 15, further comprising a second circuit and a third circuit;
wherein the plurality of fourth light sources comprise a second light source and a third light source, and the second circuit comprises:
a seventh inductor, wherein a first terminal of the seventh inductor is connected to the first output terminal of the second driving circuit, and a second terminal of the seventh inductor is connected to the first terminal of the first light source;
a seventh diode, wherein a first terminal of the seventh diode is connected to the first terminal of the seventh inductor, and a second terminal of the seventh diode is connected to the second terminal of the first light source and a first electrode of a sixth transistor; and
the sixth transistor, wherein a gate of the sixth transistor is connected to a second output terminal of the second driving circuit, and a second electrode of the sixth transistor is connected to a second grounding terminal;
wherein the third circuit comprises:
an eighth inductor, wherein a first terminal of the eighth inductor is connected to the first output terminal of the third driving circuit, and a second terminal of the eighth inductor is connected to a first terminal of the second light source;
an eighth diode, wherein a first terminal of the eighth diode is connected to the first terminal of the eighth inductor, and a second terminal of the eighth diode is connected to a second terminal of the second light source and one first terminal in the plurality of first terminals of the second switching circuit;
a ninth inductor, wherein a first terminal of the ninth inductor is connected to the first output terminal of the third driving circuit and a first terminal of a ninth diode, and a second terminal of the ninth inductor is connected to a first terminal of the third light source; and
the ninth diode, wherein a second terminal of the ninth diode is connected to a second terminal of the third light source and another first terminal in the plurality of first terminals of the second switching circuit.

20. A method for driving a light source of a projection device, wherein the projection device is the projection device according to claim 13; and
the method comprises:
supplying, by the control circuit, the second enable signal and the second driving signal to the second driving circuit, supplying, by the control circuit, the third enable signal and the at least one third driving signal to the third driving circuit, and supplying, by the control circuit, the at least one first switching signal to the at least one switching circuit, based on light emission information of the plurality of light source;
supplying, by the second driving circuit, the second current based on the second enable signal and the second driving signal;
supplying, by the third driving circuit, the third current based on the third enable signal and the at least one third driving signal;
controlling, by the at least one switching circuit, a connection between the third driving circuit and the plurality of fourth light sources to be turned on in sequence, to enable the third driving circuit to supply the third current to the plurality of fourth light sources in sequence to drive the plurality of fourth light sources to emit light in sequence based on the light emission information.
